(19) United States
(12) Patent Application Publication
(10) Pub. No.: US 2025/0314059 A1
(43) Pub. Date: Oct. 9, 2025

(54) CONCRETE ANCHOR ROD HOLDER, COUPLER AND CONCRETE ANCHOR ROD ASSEMBLY

(71) Applicant: CETRES HOLDINGS, LLC, JACKSON, WY (US)

(72) Inventor: Thomas M. ESPINOSA, Snohomish, WA (US)

(21) Appl. No.: 19/171,022

(22) Filed: Apr. 4, 2025

Related U.S. Application Data
(60) Provisional application No. 63/574,536, filed on Apr. 4, 2024.
(60) Provisional application No. 63/701,901, filed on Oct. 1, 2024.

(51) Int. Cl. E04B 1/41; F16B 33/00

(52) U.S. Cl. CPC E04B 1/4121; F16B 33/004

(57) ABSTRACT

A holder for a rod to be embedded in concrete includes a head portion elevated from a base portion by a support portion; the head portion including an opening for receiving an end portion of a rod; and the base portion for being attached to a concrete form surface, the holder being made of plastic to protect from corrosion the end portion of the rod.

### RELATED APPLICATIONS

This is a nonprovisional application claiming the priority benefit of provisional application Ser. Nos. 63/701,901, filed on Oct. 1, 2024, and 63/574,536, filed on Apr. 4, 2024, both of which are hereby incorporated by reference.

### FIELD OF THE INVENTION

The present invention is generally directed to concrete anchor rod holders, holders for items to be embedded in a concrete slab on grade, couplers and concrete anchor rod assemblies for use in hold down systems for reinforced building walls.

### BACKGROUND OF THE INVENTION

Reinforced building walls using threaded rods anchored to the foundation are disclosed in the prior art. For example, see U.S. Pat. Nos. 6,951,078, 7,762,030, 8,136,318, 8,943,777, 9,097,000, 9,097,001, 9,416,530 and 9,874,009, hereby incorporated herein by reference. These walls are designed to hold the walls against tension loads or forces caused by earthquakes and/or high winds.

### SUMMARY OF THE INVENTION

The present invention provides a holder for a rod to be embedded in concrete, comprising a head portion elevated from a base portion by a support portion; the head portion including an opening for receiving an end portion of a rod; and the base portion for being attached to a concrete form surface, the holder being made of plastic to protect from corrosion the end portion of the rod.

The present invention also provides a holder for a rod to be embedded in concrete, comprising a head portion having alternating first and second U-shaped portions defining a first opening; a first base portion having third and fourth alternating U-shaped portions defining a second opening; and a barrier wall located between the head portion and the first base portion to isolate the first opening from the second opening.

The present invention further provides an anchor rod assembly to be embedded in concrete, comprising a moisture barrier for being disposed on a ground surface; a body with a flat bottom surface supported on the moisture barrier; the body has an opening; and a rod is operably attached to the opening.

The present invention also provides an anchor rod assembly for being disposed on a moisture barrier on a ground surface, comprising a body with a flat bottom surface for being supported on the moisture barrier; a body with a flat bottom surface supported on the moisture barrier; the body has an opening; a rod holder has a first end and a second end; the first end is attached to the opening of the body; a rod has an end portion attached to the second end; and the second end has an opening for receiving the end portion of the rod.

The present invention also provides an anchor rod assembly to be embedded in concrete, comprising a rod holder for being positioned on a concrete form surface; a rod having a first end portion and a second end portion, the first end portion being operably attached to the rod holder; an anchor body attached to the rod; a coupler having a first end opening and a second end opening, the first end opening being attached to the second end portion of the rod, the second end opening for being attached to a load; and the first end opening having an internal thread with a first portion for minimum thread engagement of the second end portion of the rod, and a second portion for height adjustment of the coupler, the second portion being deeper into the first end opening than the first portion, the coupler being adjustable within the second portion relative to a reference point.

The present invention also provides a coupler to be embedded in concrete, comprising a body having a first end portion and a second end portion; the first end portion including a threaded first opening, the second end portion including a threaded second opening, the first end portion for being accessible for attaching a threaded rod after concrete is poured around the coupler; an internal partition wall disposed between the threaded first opening and the threaded second opening to seal the threaded first opening from the threaded second opening; and the threaded first opening has a first minimum thread engagement depth.

The present invention further provides a coupler to be embedded in concrete, comprising a body having a first end portion and a second end portion; the first end portion including a threaded first opening, the second end portion including a threaded second opening, the first end portion for being accessible for attaching a first threaded rod after concrete is poured around the coupler; and the body having a threaded first opening with a first portion for minimum thread engagement of a rod and a second portion for height adjustment of the body, the second portion being deeper into the threaded first opening than the first portion, the body being adjustable within the second portion relative to a reference point.

The present invention further provides a coupler for being embedded in concrete, comprising a body having a first end portion and a second end portion; the first end portion including a threaded first opening, the second end portion including a threaded second opening, the first end portion for being accessible for attaching a first threaded rod after concrete is poured around the coupler, the threaded second opening for receiving an end portion of a second rod; and an interior partition wall disposed between the threaded first opening and the threaded second opening to seal the threaded first opening from the threaded second opening; and the second end portion including a first sight hole located immediately below a bottom surface of the interior partition wall for allowing wet concrete to fill a void between a top of the second rod and the partition wall.

The present invention further provides a threaded rod for attachment to a coupler embedded in concrete, wherein the threaded rod comprises a threaded first end for being threaded to a coupler already embedded in concrete; the threaded rod having a first reference point above the threaded first end; and the first reference point being a known distance above a second reference point after the threaded rod is threaded to the coupler, the distance for indicating that the threaded rod has penetrated the coupler with minimum thread engagement. The present invention also provides a holder for positioning an item inside a concrete slab on grade prior to concrete pouring, comprising a head portion elevated from a base portion by a support portion; the head portion including an opening for attaching to the item; and the base portion for being attached to a concrete form surface, the holder being made of plastic to protect the item from corrosion.

### BRIEF DESCRIPTION OF THE DRAWINGS

FIGS. 1A-1B are perspective views of a rod holder embodying the present invention.

FIGS. 2A-2B are perspective views of the holder attached to the ground and supporting a rod.

FIGS. 3A-3C are perspective views of another embodiment of a rod holder.

FIGS. 3D-3E are cross-sectional and enlarged views of the head portion of the holder of FIGS. 3A-3C.

FIGS. 4A-4I are views of a coupler used with the rod supported by the holder disclosed herein.

FIGS. 5A-5E are views of another embodiment of a rod holder disposed on a moisture barrier covering a ground surface.

FIGS. 6A-6H are views of another embodiment of a rod holder disposed on a moisture barrier covering a ground surface.

FIGS. 7A-7D are views of another embodiment of a rod holder disposed on a moisture barrier covering a ground surface.

FIGS. 8A-8C are perspective views of three embodiments of a rod holder.

FIGS. 9A-9D are perspective views of four embodiments of a rod holder.

FIGS. 10A-11E are perspective views of the rod holder shown in FIG. 9D with an anchor rod and an anchor body, the rod holder being attached to the ground via a ground rod or a base.

FIGS. 12A-12D are perspective views of the rod holder shown in FIG. 8B with an anchor rod and an anchor body, the rod holder being attached to the ground via a stake rod or a coupler with a ground rod.

FIGS. 13A-13E are perspective views of the rod holder shown in FIG. 9D with an anchor rod and an anchor body, the rod holder being attached to the ground.

FIGS. 14A-14C are perspective views of a coupler attached to an anchor rod.

FIGS. 15A-15I are perspective and cross-sectional views of the coupler shown in FIGS. 4A-4I and attached to an anchor rod and a rod holder.

FIGS. 16A-16E are perspective views of the assemblies shown in FIGS. 15A-15I embedded in concrete.

FIGS. 17A-17D show different ways of marking a threaded rod to check for minimum thread engagement with the coupler embedded in concrete shown in FIGS. 16A-16E.

FIGS. 18A-18F are perspective views of the threaded rod shown in FIGS. 17A-17D and attached to the coupler shown in FIGS. 4A-4I embedded in concrete.

FIGS. 19A-20C are perspective views of a threaded rod attached to the coupler shown in FIGS. 4A-4I embedded in concrete, the rod being measured to the top of the rod to determine minimum thread engagement with the coupler.

FIGS. 21A-22D are perspective views of the rod holder shown in FIGS. 1A-2B.

FIGS. 22A-22H are perspective view of the rod holder shown in FIGS. 3A-3E.

FIGS. 23A-23D are perspective views, some in cross-section, of a sealing member.

FIGS. 24A-24F are perspective views, some in cross-section, of an embodiment of a sealing member.

FIGS. 25A-25D are perspective views, some in cross-section, of an embodiment of a sealing member.

### DETAILED DESCRIPTION OF THE INVENTION

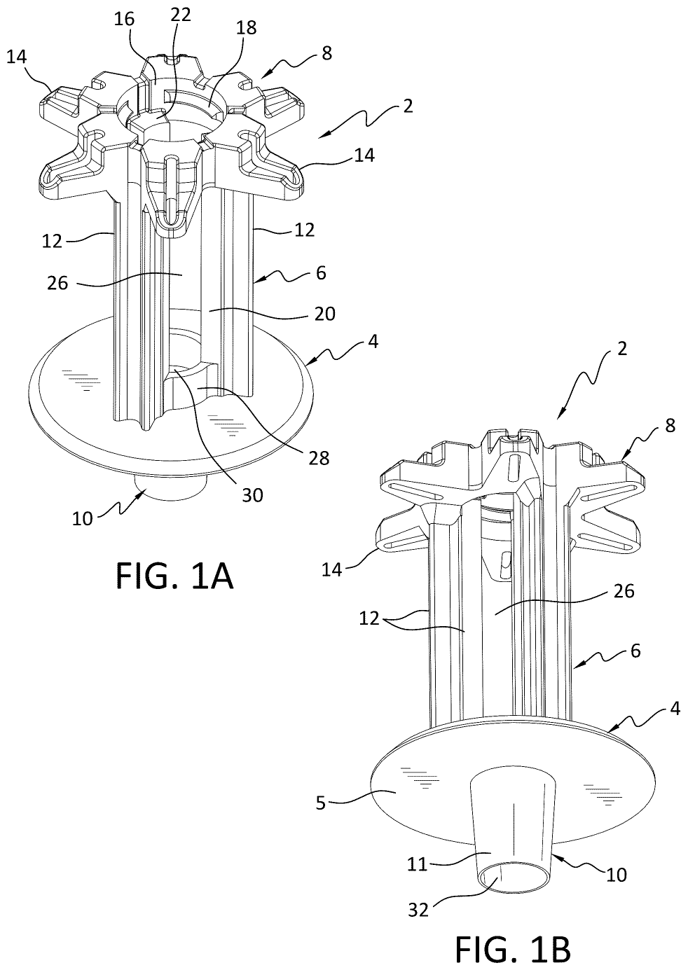

Referring to FIGS. 1A-1B, a concrete anchor rod holder 2 is disclosed embodying the present invention. The holder 2 includes a base portion 4, leg portions 6 extending upwardly from the base portion 4, and a head portion 8 disposed at the upper end portions of the leg portions 6. The leg portions 6 provide support and elevation to the head portion 8 above the base portion 4. The base portion 4 has a flat bottom surface 5. A tube portion 10 with a conical outside surface 11 extends downwardly from the base portion 4. The holder 2 is preferably made of one piece of molded plastic or other suitable materials to isolate the anchor rod 24 from the moisture of the ground 36 for protection against corrosion.

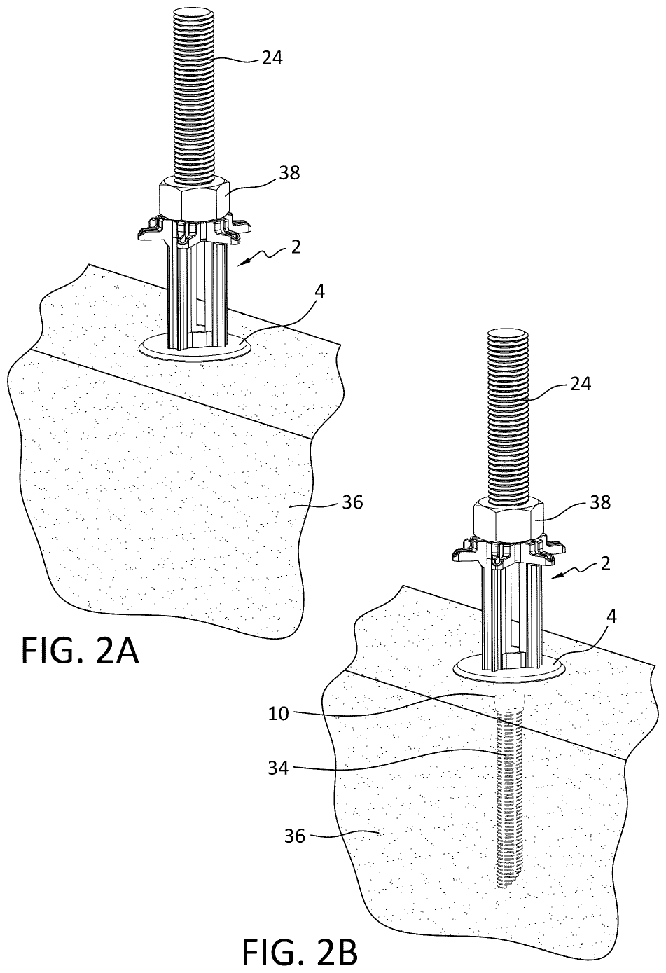

The base portion 4 may be planar with a circular shape. The leg portions 6 includes pairs of adjacent members 12 that support respective adjacent arms portions 14. The head portion 8 includes the arm portions 14 that extend radially outwardly. The arm portions 14 advantageously provides leverage when positioning the holder on the ground. A central opening 16 includes thread sections 18. The pairs of adjacent members 12 include a spine member 20 that extends into the opening 16 to provide a stop portion 22 for an anchor rod 24 (see FIG. 2A) or a bolt. The stop portion 22 advantageously limits the penetration of the anchor rod 24 into the opening 16. The pairs of members 12 are arranged around the opening 16 such that openings 26 are provided therebetween to allow the wet concrete to flow freely around to avoid forming air pockets during pouring of the concrete. The opening 32 of the tube portion 10 is used for receiving an end portion of a ground rod 34 buried in the ground 36 (see FIG. 2B). The opening 32 may be provided with threads, preferably segmented. The rod 34 may be a rebar.

A sleeve portion 28 is provided at the bottom of the leg portions 6, attached to the base portion 4 and the spine portion 20. The bottom portion of the sleeve portion 28 is closed by the base portion 4 at 30.

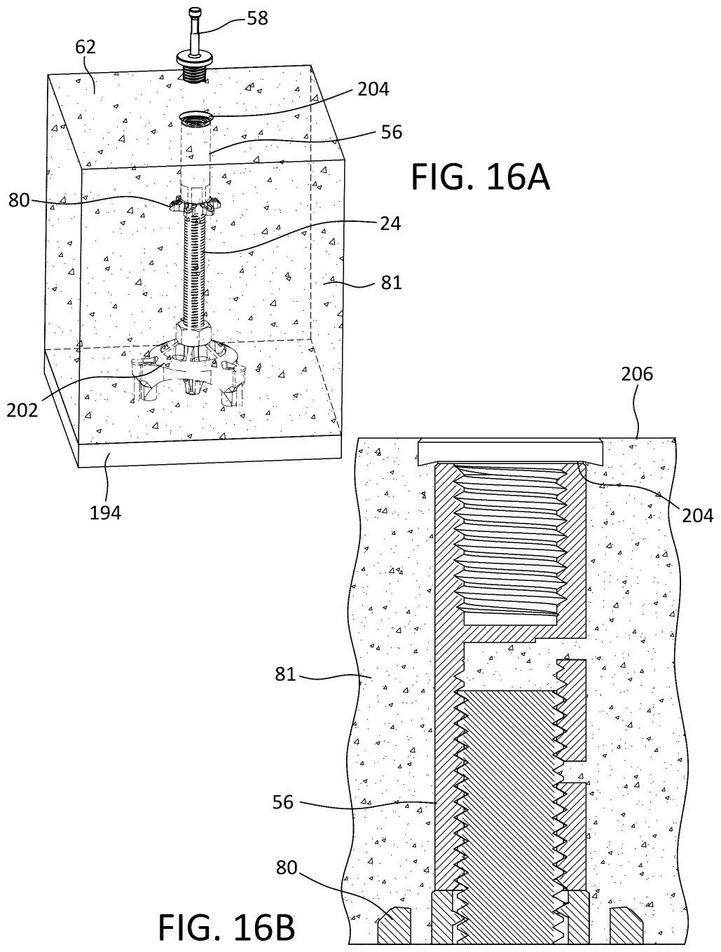

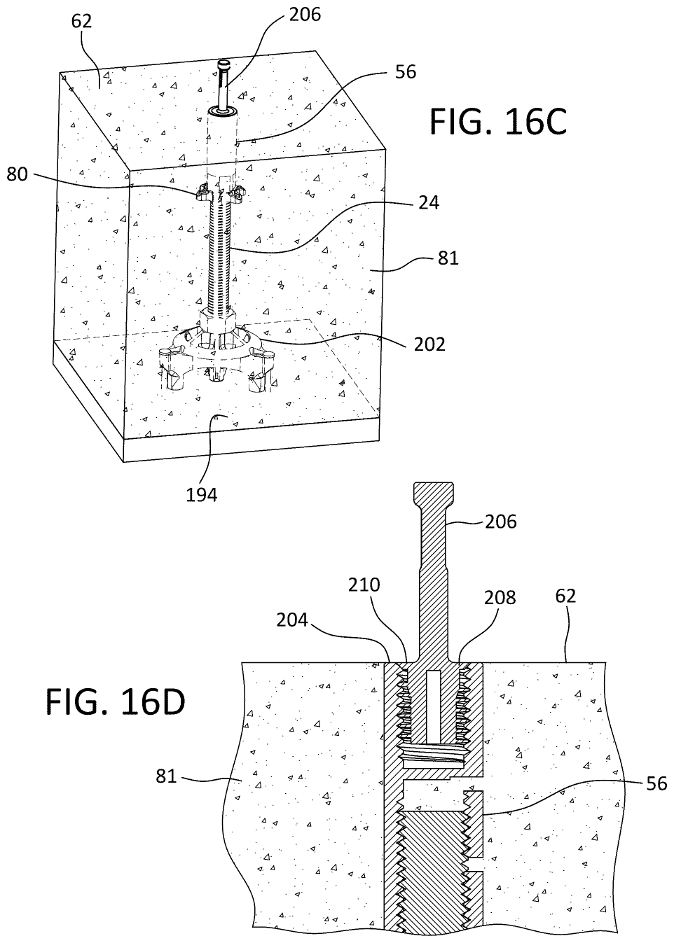

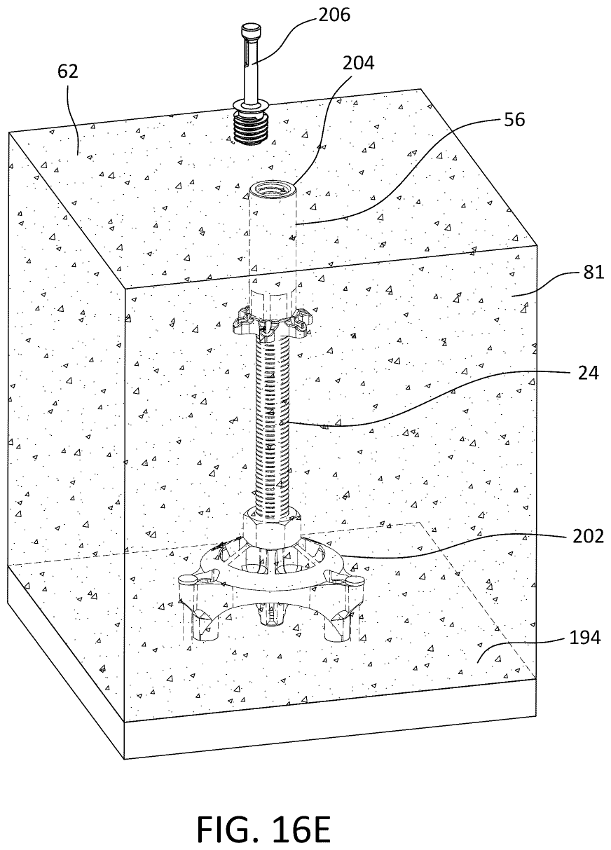

Referring to FIGS. 2A-2B, the holder 2 is used to support the anchor rod 24 above the ground 36 prior to pouring a concrete slab on grade or other concrete structure to embed the holder 2 and the anchor rod 24 and place the bottom of the anchor 24 a distance above the ground. The concrete slab on grade is similar to the concrete structure 81 (FIG. 16C) where the formboard 194 is replaced by the ground 36 as the concrete form surface. A hex nut 38 is threaded to the rod 24 to lock the rod 24 in place and to provide an anchor body for resisting the load applied to the anchor rod 24 after being embedded in concrete. The nut 38 further provides the function of an anchor body for creating a shear cone to resist an upwardly directed load on the anchor rod 24. The base portion 4 advantageously provides a stable base on the ground surface. The tube portion 10 when inserted into the ground advantageously provides lateral stability to the holder 2. The ground rod 34 provides further stability to the holder 2.

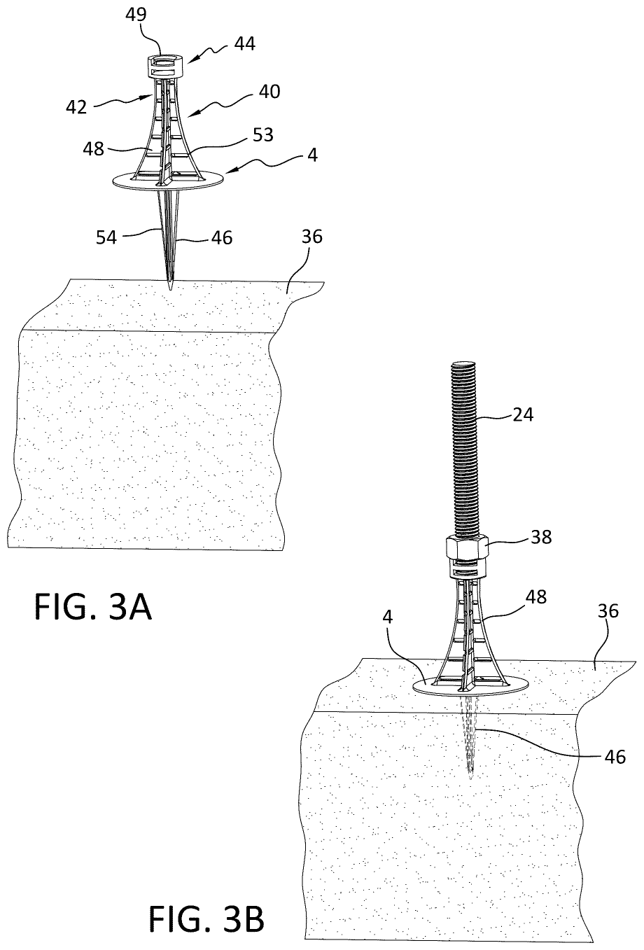

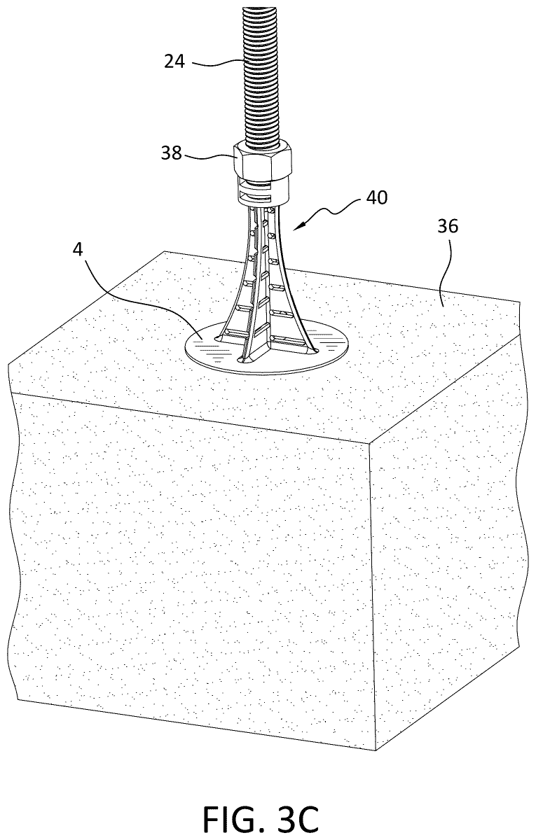

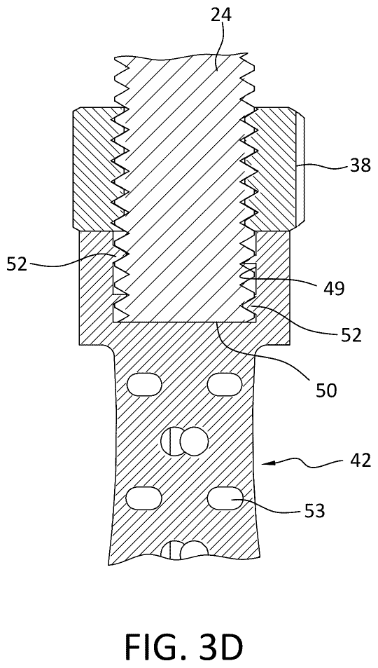

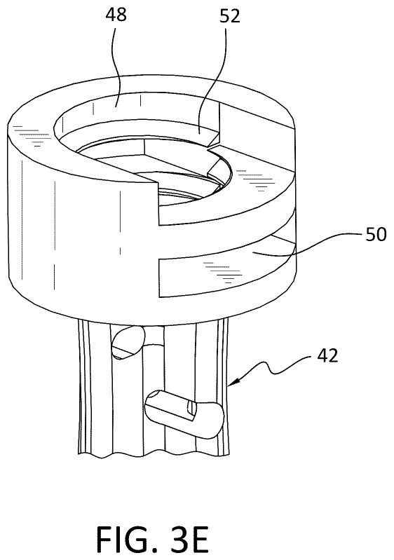

Referring FIGS. 3A-3D, another embodiment of an anchor rod holder 40 is disclosed. The holder 40 includes a base portion 4, a support portion 42 supported by the base portion 4, and a head portion 44 supported by the support portion 42. A spike portion 46 extends downwardly from base portion 4. The support portion 42 advantageously elevates the head portion 44 above the base portion 4. The holder 40 is preferably made of plastic or other suitable materials to advantageously isolate the anchor rod 24 from the moisture of the ground 36 for protection against corrosion.

The support portion 42 includes tapered members 48 forming an X shape in cross-section. The tapered members 48 are wide at the base portion 4 and narrow at the head portion 44. Openings 53 in the tapered members 48 advantageously allow the wet concrete to freely flow around to avoid forming air pockets during the pouring of the concrete.

The head portion 44 includes an opening 49 for receiving an end portion of the anchor rod 24. The opening 48 includes a bottom wall portion 50 for providing a stop to the rod 24. The opening 48 is preferably threaded with thread segments 52 for engaging the threads of the rod 24.

The spike portion 46 includes triangular members 54 forming an X shape in cross-section. The triangular member 54 may also be cross-shaped (“+”) in cross-section, each triangular member being perpendicular to each other. The spike portion 46 when driven into the ground 36 advantageously provides lateral stability to the holder 48. The base portion 4 advantageously provides a stable base on the ground surface.

The spike portion 46 may be replaced with a tubular portion attached to the base portion 4 and receiving an end portion of a rod or rebar, as shown in FIG. 2B.

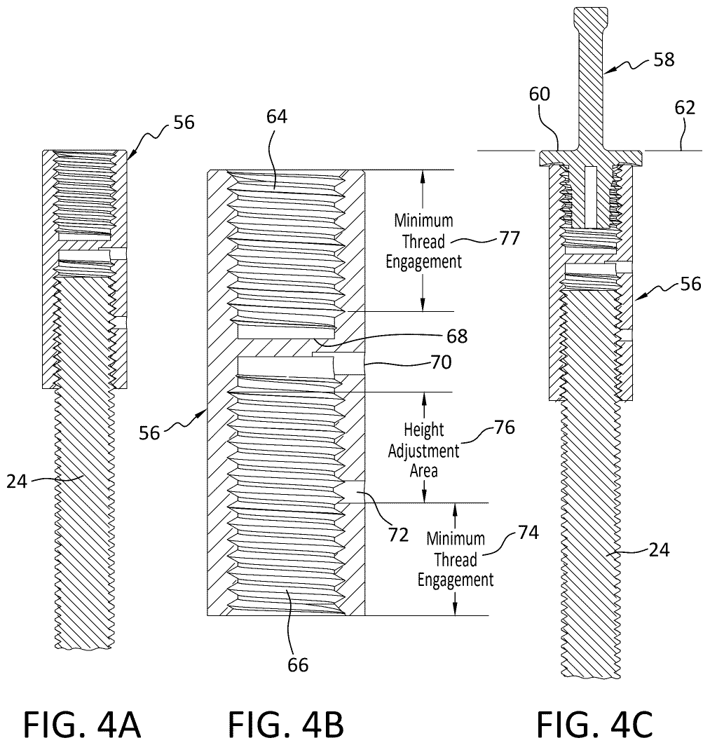

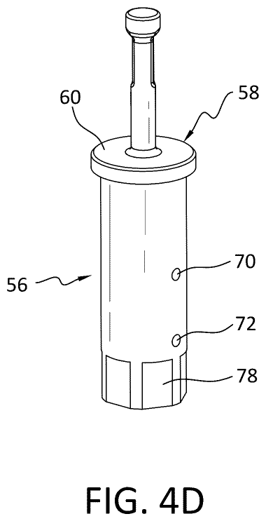

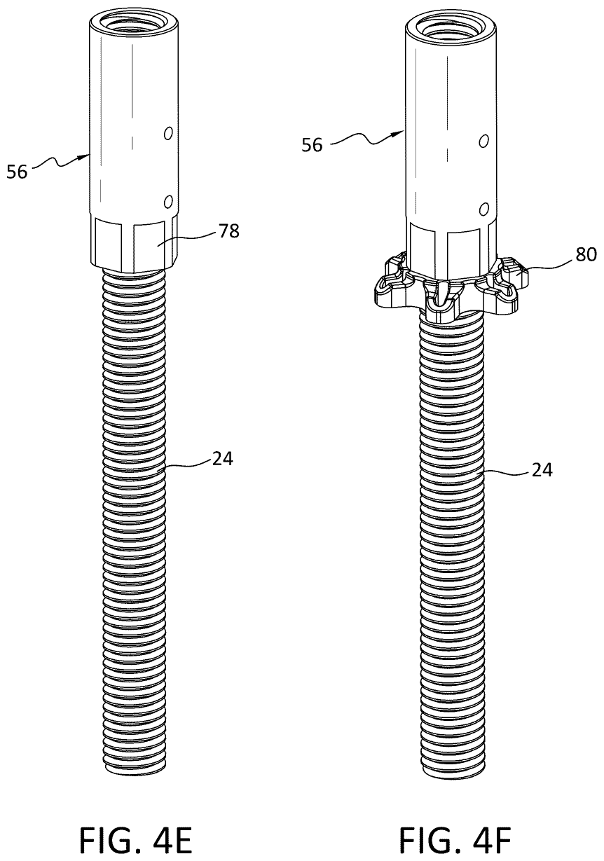

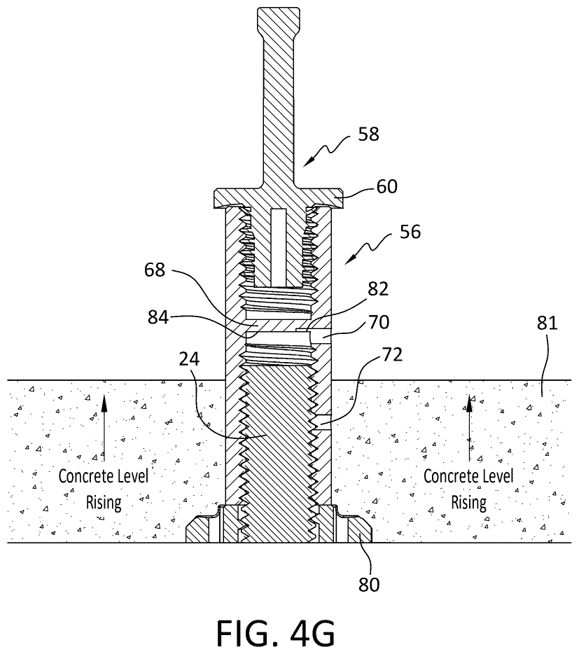

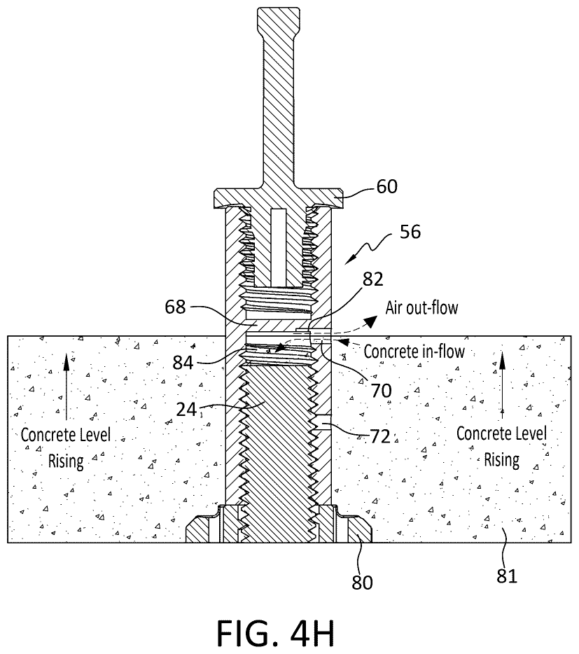

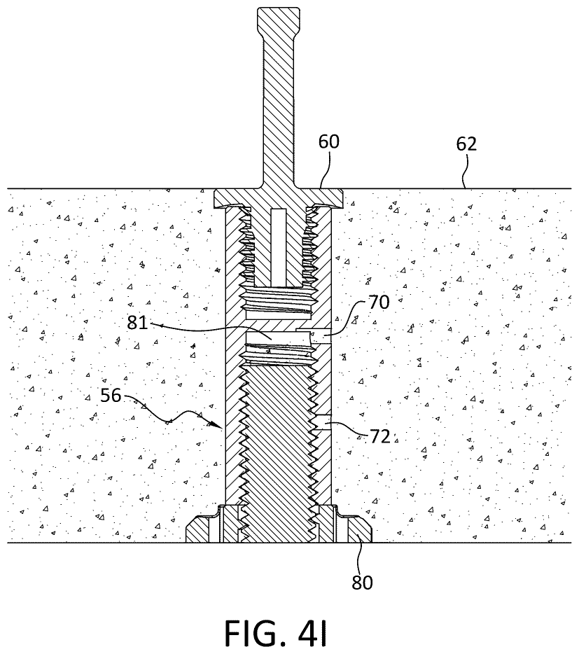

Referring to FIGS. 4A-4C, a coupler 56 is attached to the end of the anchor rod 24. The coupler 56 is used to attach to a threaded rod for connecting a load, such as a stud wall or other structures, to the anchor rod 24. A plug 58 is inserted to the open end of the coupler 56 to prevent wet concrete from entering the coupler 56. The flange portion 60 of the plug 58 is positioned relative to a reference point, preferably aligned at the same level as the top surface 62 of the concrete slab. The plug 58 is not limited to that shown. Other plugs, such as those disclosed in nonprovisional application Ser. No. 18/801,468, filed on Aug. 12, 2024, hereby incorporated by reference, may also be used.

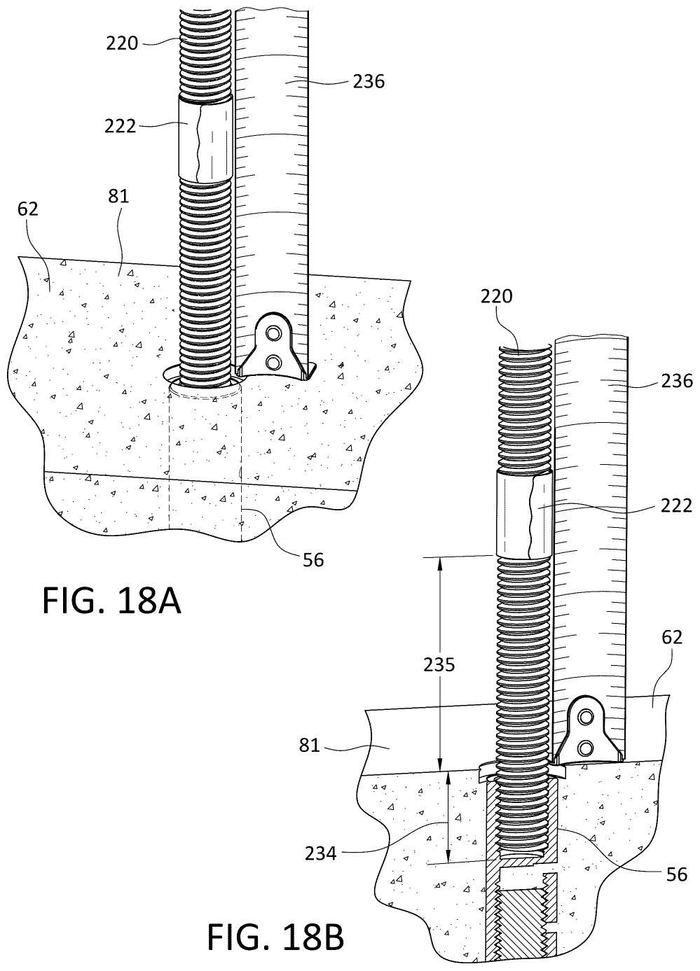

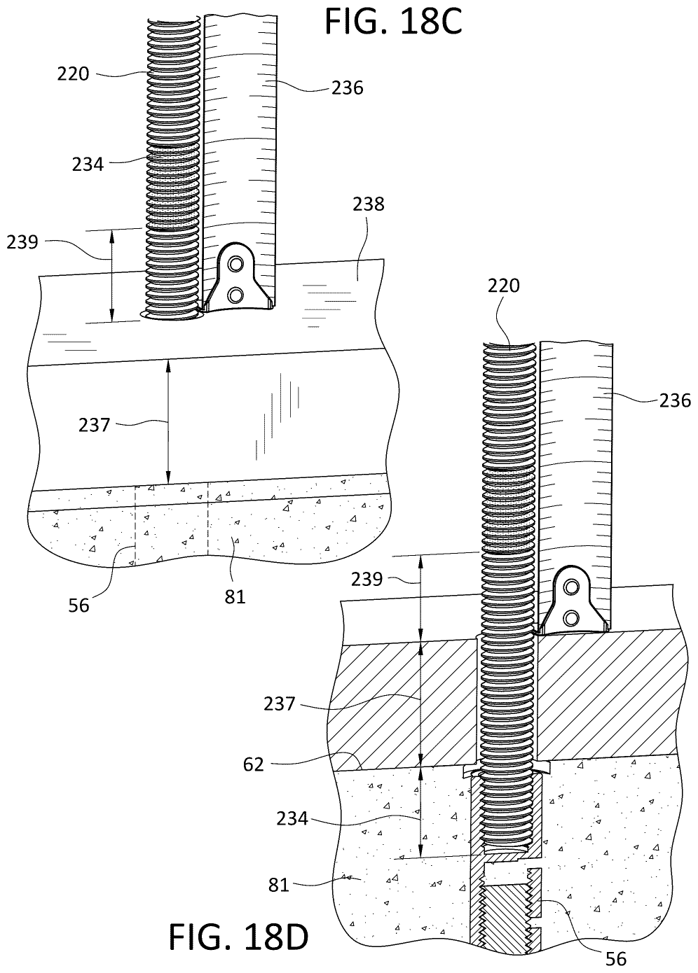

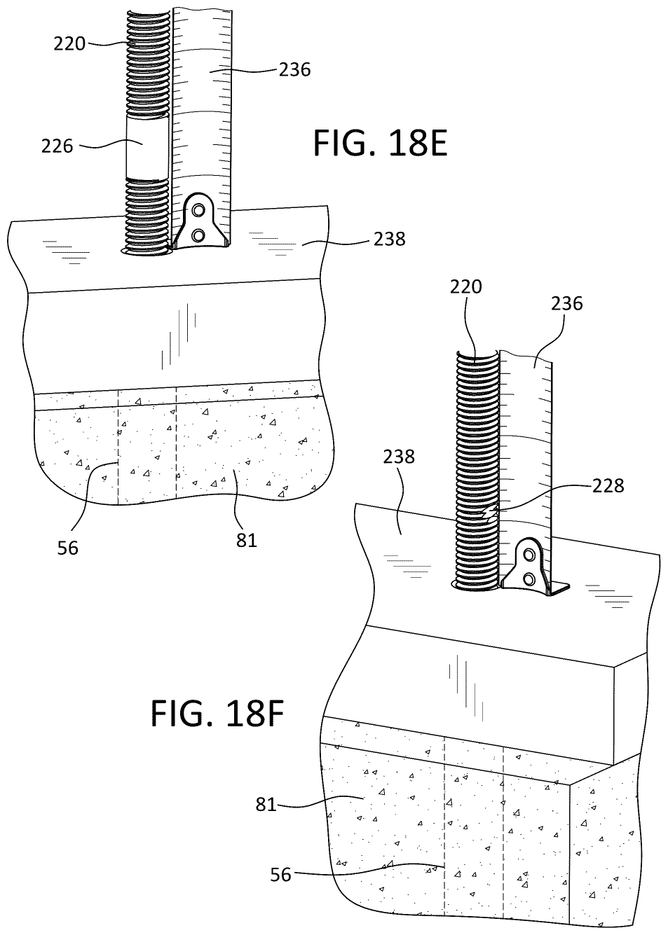

Referring to FIG. 4B, the coupler 56 includes an upper threaded opening 64 and a lower threaded opening 66 separated with an internal partition wall 68. The wall 68 advantageously seals the upper opening 64 from the lower opening 66 of concrete slurry as it rises and fills the lower opening 66. With the plug 58 and the wall 68, the thread in the upper opening 64 advantageously remains relatively clean of concrete so as to be ready for threading a rod. The threaded openings 64 and 66 may have different diameters. The partition wall 68 completely isolates the upper threaded opening 64 from the lower threaded opening 66 so that no concrete can flow from the lower threaded opening 66 to the upper threaded opening 64. The upper threaded opening 64 is deep enough to provide the minimum required thread engagement of the rod 220 (FIG. 18A) to fully transmit the expected load to the anchor rod 24.

The lower opening 66 has a lower sight hole 72. An upper sight hole 70 may be provided but it is not necessary for the proper functioning of the coupler 56. The distance 74 from the bottom of the coupler to the sight hole 72 provides a number of threads to provide the minimum thread engagement of the anchor rod 24 required to handle the expected load. The distance 76 above the lower sight hole 72 and below the partition wall 68 or the upper sight hole 70 advantageously provides a number of threads to advantageously provide vertical adjustment for the coupler 56 when aligning to the same level the flange portion 60 of the plug 58 to a reference point, such as the top surface 62 of the concrete slab or structure being constructed. The vertical adjustment of the coupler 56 is preferably along a direction perpendicular to the top surface 62. The upper sight hole 70 is immediately below the partition wall 68.

At a construction site, several anchor rods with respective couplers 56, plugs 58 and rod holders would be laid out on the ground surface or concrete form prior to pouring of a concrete slab or other concrete structure. When the top end of rod 24 is placed about halfway of the distance 76, then the top edge of the coupler 56 can be adjusted up or down to align to the same level as a reference point, such as the top surface of the concrete slab to be poured, by turning the coupler 56 clockwise or counterclockwise. The distance 77 indicates the minimum thread engagement of the rod to be attached to the upper threaded opening 64. The known distance 77 is advantageously used to measure the depth of penetration of the rod into the opening 64 from a known reference mark on the rod, such the end of the rod, and another reference point, such as the top of a base plate, thus ensuring that the rod has reached the minimum thread engagement with the opening 64.

Referring to FIG. 4D, the coupler 56 may include flat surfaces 78, preferably in hexagonal configuration, for engaging a wrench or other tools when adjusting the height of the coupler.

Referring to FIGS. 4E-4F, a hex nut 79 or a plastic nut 80 may be used to lock the coupler to the anchor rod 24 after adjusting the coupler to the desired height. The plastic nut 80 is disclosed in U.S. Pat. No. 8,806,835, incorporated herein by reference.

Referring to FIGS. 4G-4I, the divider wall 68 has a bottom surface with a recess or undercut 82 communicating with the upper sight hole 70. The top end of the rod 24 is shown within the height adjustment distance 76. As the wet concrete 81 rises, the lower sight hole 72 fills up with concrete. As the concrete continues to rise, the concrete starts to fill the void 84 through the upper sight hole 70. The void 84 is located in the adjustment distance 76 and varies in size depending on how far the end of the rod 24 has entered the adjustment distance. Concrete entering the upper sight hole 70 expels the air inside the void 84 through the upper part of the sight hole 70 and eventually through the recess or undercut 82. Consequently, the void 84 is advantageously filled with the concrete 81 to eliminate any air pocket inside the coupler that could collect moisture and cause corrosion. The top surface 62 of the concrete slab being poured preferably aligns with the top surface of the flange portion 60 of the plug 58. The flange portion 60 advantageously keeps the wet concrete from entering the upper opening 64 of the coupler 56.

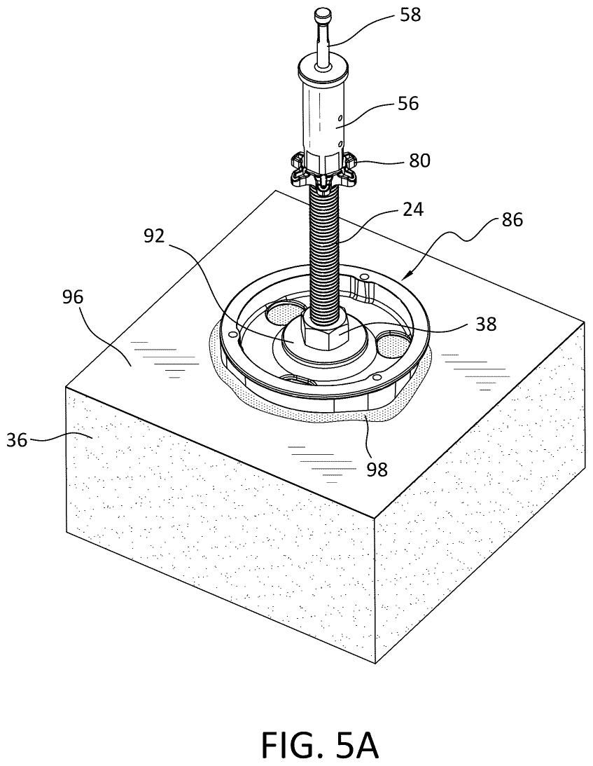

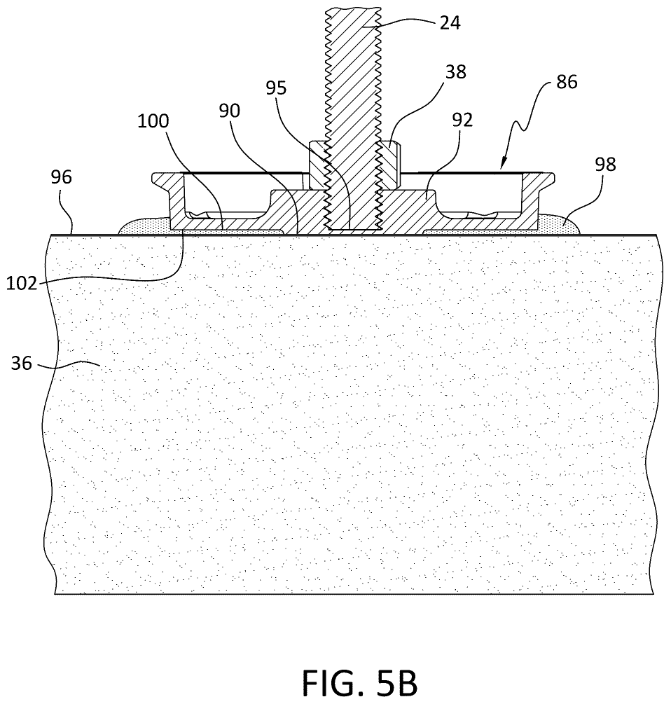

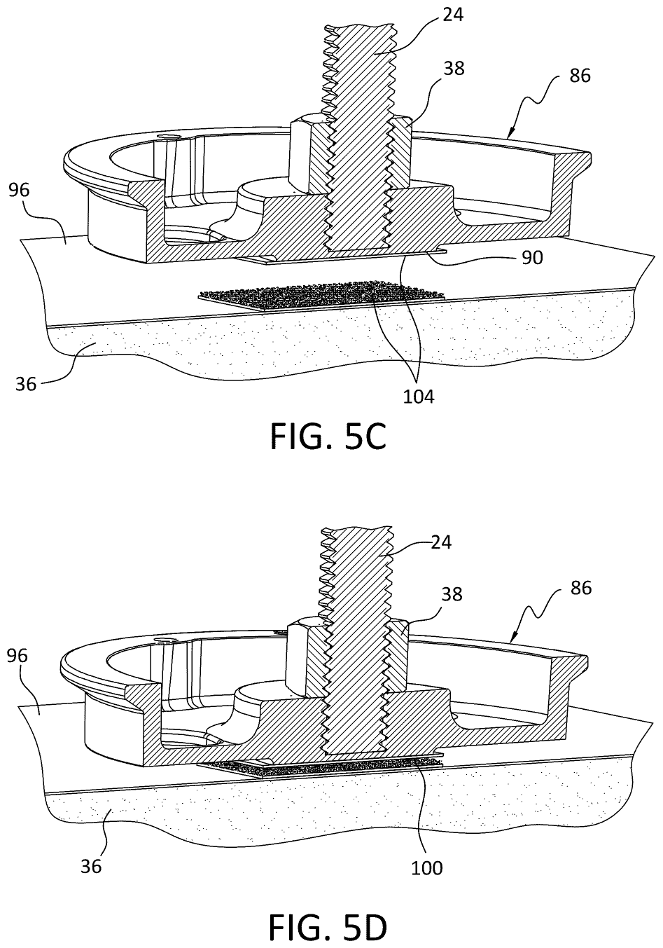

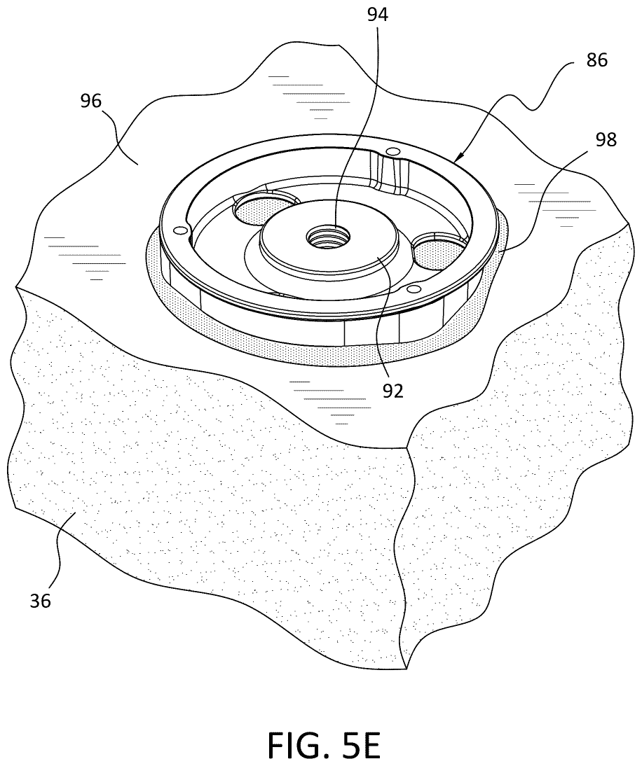

Referring to FIGS. 5A-5B, a rod holder 86 supports the anchor rod 24. The holder 86 has a base portion 88 with a flat or planar bottom surface 90, and a projecting central portion 92 with a threaded opening 94 for mating with an end portion of the rod 24. The bottom of the opening 94 is preferably closed with a bottom wall 95 to advantageously isolate the bottom of the rod 24 from the top surface of the ground 36 to prevent corrosion from ground moisture. The hex nut 38 locks the rod 24 to the holder 86. The holder 86 is preferably made of plastic or other suitable materials to advantageously isolate the anchor rod 24 from the ground moisture for protection against corrosion. The rod holder 86 is similar to that disclosed in U.S. Pat. No. 8,943,777, incorporated herein by reference.

The top surface of the ground 36 may be covered with a moisture barrier 96. The holder 86 may be attached to the moisture barrier 96 with a layer of glue 98. The glue 98 is thick enough to fill the space 100 underneath a raised portion 102 to advantageously provide a stable base for the holder 86. The moisture barrier 96 is not penetrated by the rod 24. The bottom wall 95 advantageously ensures that the rod 24 does not penetrate the moisture barrier 96. Keeping the moisture barrier unpenetrated assures that moisture from the ground 36 will be prevented from migrating to the concrete, thus avoiding corrosion of the anchor rod 24 and the hex nut 38.

Referring to FIGS. 5C-5D, the holder 86 may be attached to the moisture barrier 96 with a VELCRO fastener 104 attached to the bottom surface 90 and the moisture barrier 96. The fastener 104 advantageously provides lateral adjustment of the holder 86 as needed. A double-sided adhesive tape pre-attached to the bottom surface 90 may also be used.

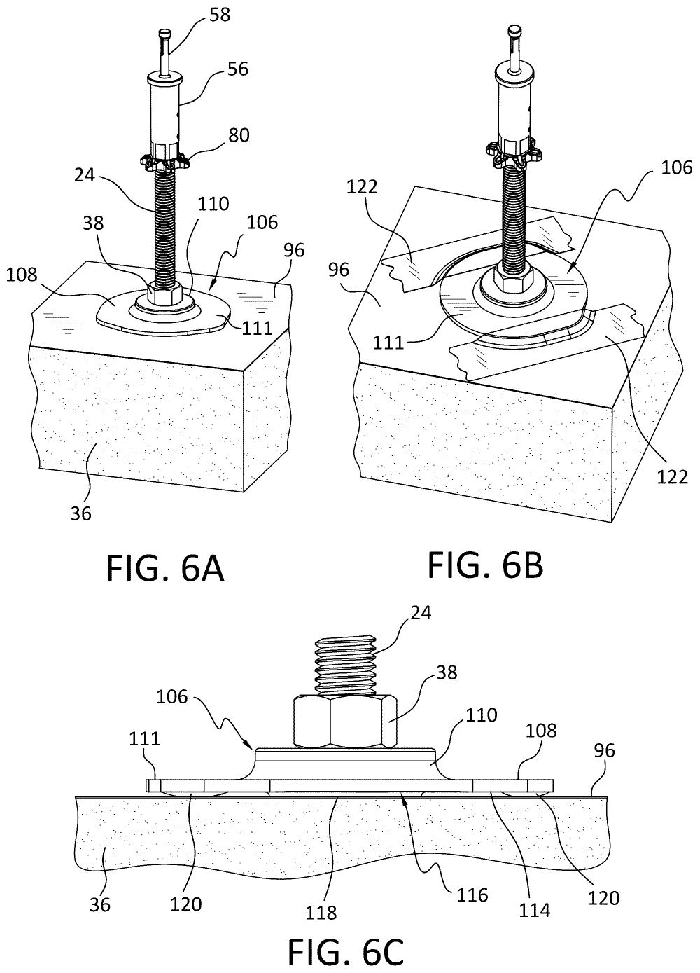

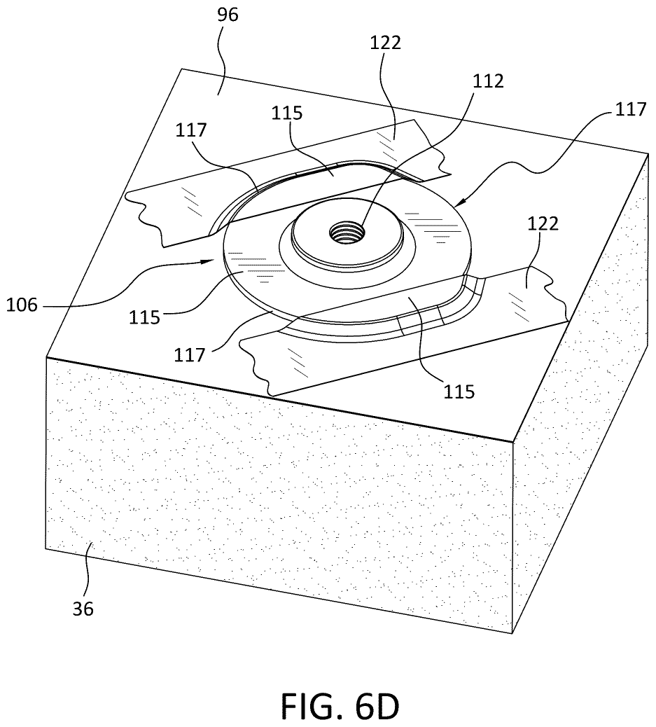

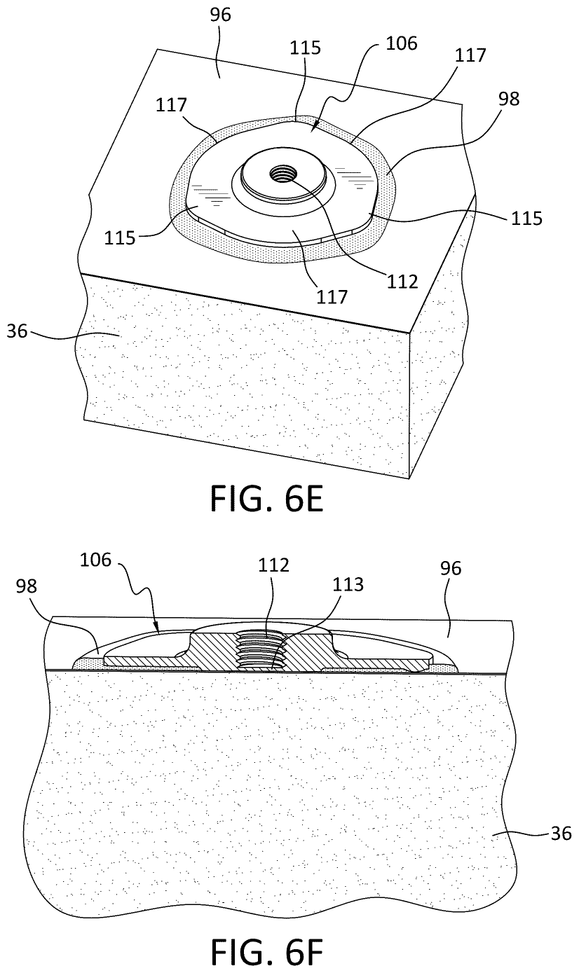

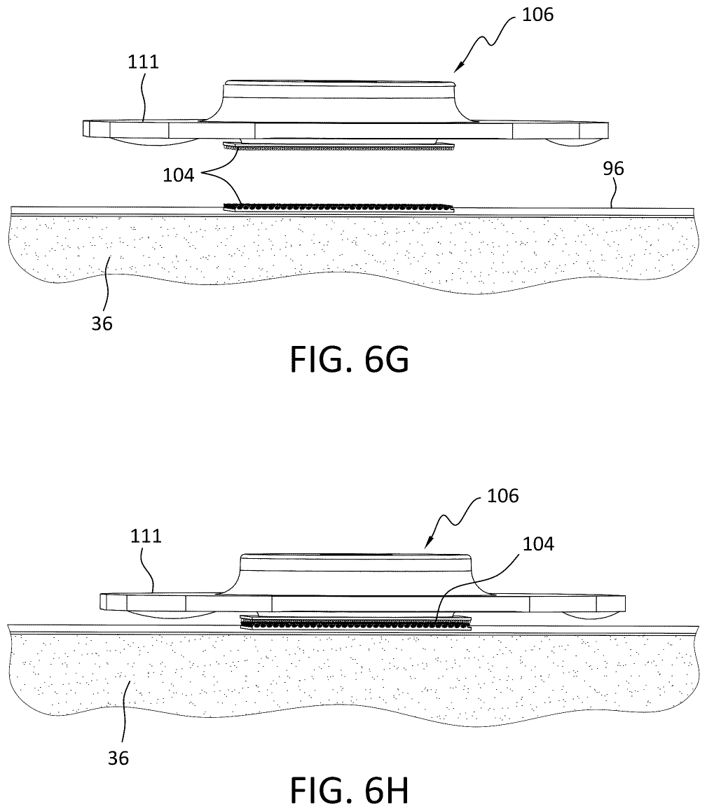

Referring to FIGS. 6A-6H, a rod holder 106 has a planar base portion 108 and a central raised portion 110 with a threaded opening 112. The base portion 108 has an unobstructed peripheral planar top surface 111. The base portion 108 is non-circular with 3 corners 115 and a convex-shaped edges 117 between the corners. The bottom of the opening 112 is preferably closed with a bottom wall 113 to advantageously isolate the bottom of the rod 24 from the surface of the ground 36 to prevent corrosion from ground moisture. In addition, the moisture barrier 96 is not penetrated by the rod 24 to ensure the integrity of the moisture barrier 96 to prevent moisture seepage into the concrete, thus protecting the anchor rod 24 and the hex nut 38 from corrosion. The base portion 108 has a flat bottom surface 114 raised above the moisture barrier 96 by a central projection portion 116 with a flat bottom surface 118 and by several convex-shaped projections 120. The holder 106 may be attached to the moisture barrier 96 with adhesive tapes 122 overlapping the top surface 111, glue 98 disposed underneath the base portion 108 or VELCRO fastener 104 attached to the bottom surface 118. A double-sided adhesive tape, pre-attached to the bottom surface 118, may also be used. The unobstructed peripheral planar top surface 111 of the holder 106 advantageously facilitates the use of adhesive tapes 122 in attaching the holder 106 to the moisture barrier 96. The corners 115 advantageously reduces rotational movement of the base portion 108 under the adhesive tapes 122. The holder 106 is preferably made of plastic or other suitable materials to advantageously isolate the anchor rod 24 from the ground moisture for protection against corrosion.

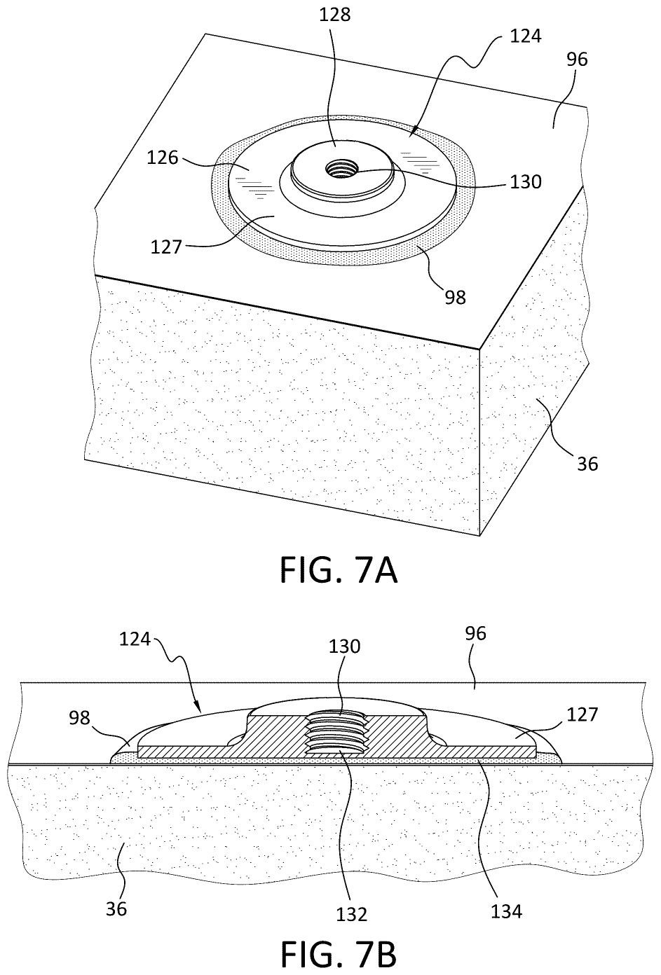

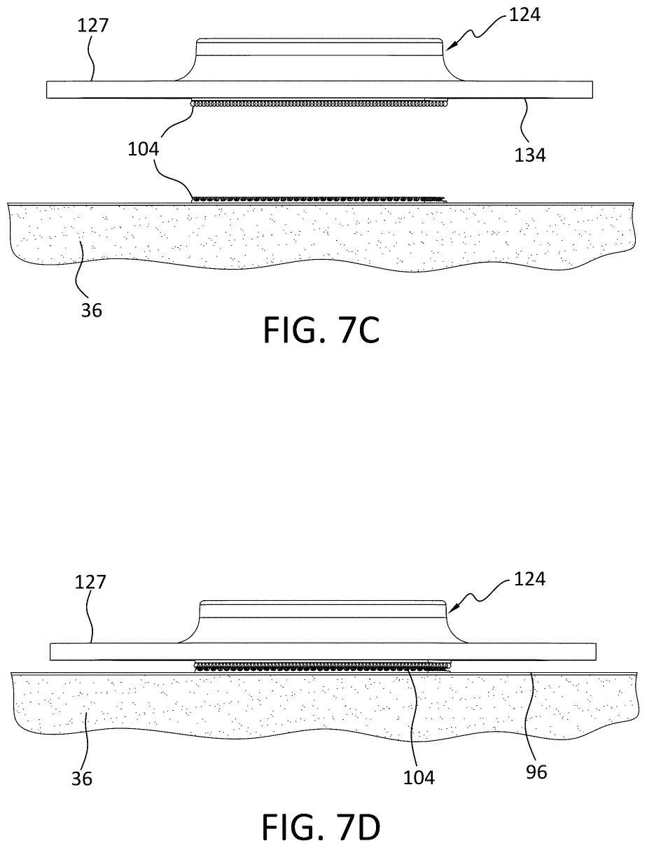

Referring to FIGS. 7A-7D, a rod holder 124 has a planar base portion 126, a raised central portion 128 with a threaded opening 130. The base portion 126 is circular in top view. The bottom of the opening 130 is preferably closed with a bottom wall 132 to advantageously isolate the bottom of the rod 24 from the top surface of the ground 36 to prevent corrosion from ground moisture. The base portion 126 has an unobstructed peripheral planar top surface 127. The base portion 126 has an unobstructed planar bottom surface 134. The holder 124 may be attached to the moisture barrier 96 with glue 98 disposed between the bottom surface 134 and the moisture barrier 96, VELCRO fastener 104 attached to the bottom surface 134 or adhesive tapes 122 overlapping the top surface 127. A double-sided adhesive tape pre-attached to the bottom surface 134 may also be used. The unobstructed planar top surface 127 of the holder 124 advantageously facilitates the use of the adhesive tapes 122 in attaching the holder 124 to the moisture barrier 96 (see FIG. 6D). The holder 124 is preferably made of plastic or other suitable materials to advantageously isolate the anchor rod 24 from the ground moisture for protection against corrosion.

The base portions 108 and 126 are not limited to the shape shown. Other geometric shapes, such as circular, rectangular, hexagonal, triangular or other shapes may be used.

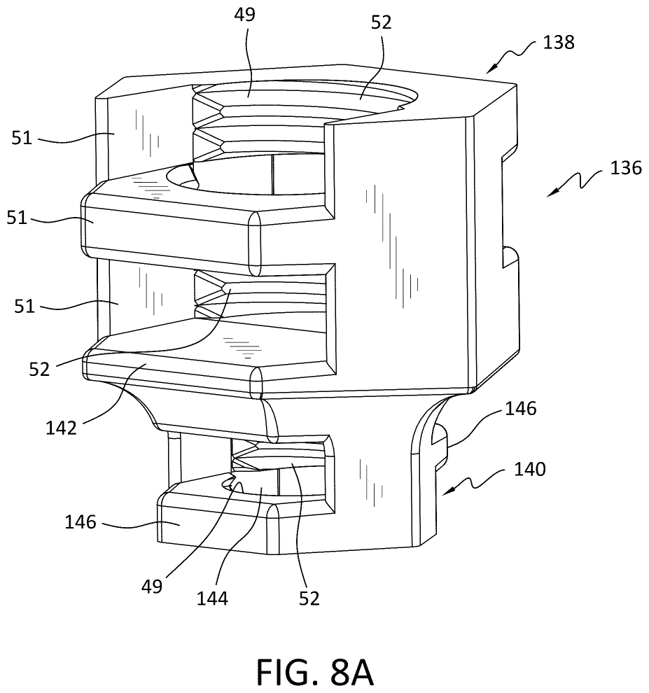

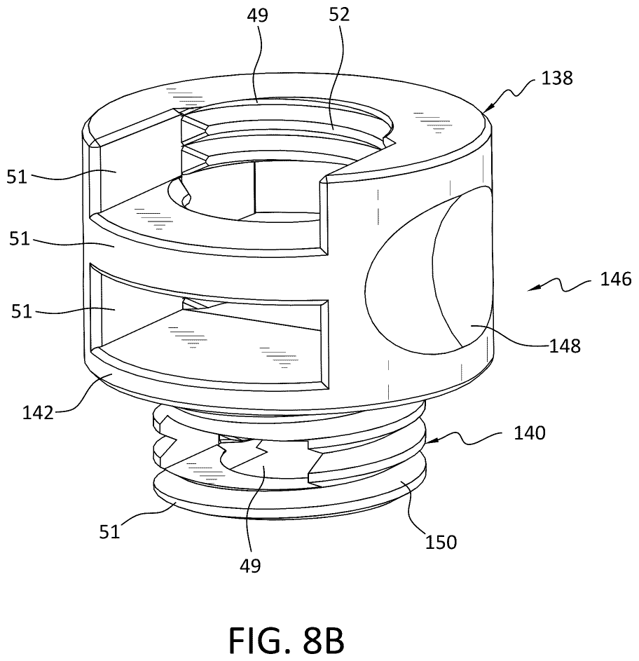

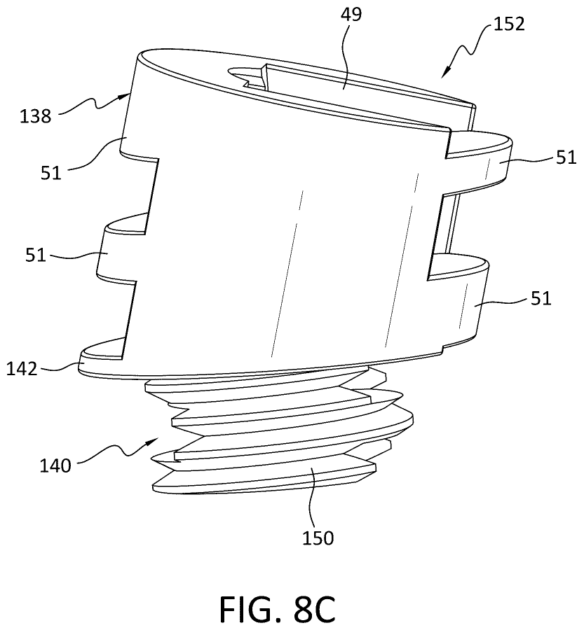

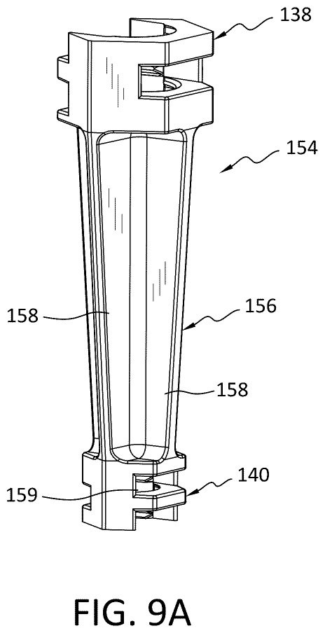

Referring to FIG. 8A, another embodiment of a rod holder 136 is disclosed. The rod holder 136 includes a head portion 138 and a base portion 140. The head portion 138 is similar to the head portion 44 of the rod holder 40, including thread segments 52 and opening 49 made of alternating U-shaped portions 51 with respective threads 52. A barrier wall 142 advantageously separates the head portion 138 from the base portion 140, thereby providing a separation distance therebetween. The head portion 138 is shown with hexagonal shape, but other shapes, such as cylindrical as shown with the rod holder 40 may also be used. The base portion 140 includes an opening 144 made up of multiple U-shaped members 146 with respective threads 52. The opening 49 in the head portion 138 is used to hold the rod 24. The base portion 140 is used to hold the rod 34, as shown in FIG. 2B.

Referring to FIG. 8B, another embodiment of a rod holder 146 is disclosed. The rod holder 146 is similar to the rod holder 138, except that the head portion 138 is cylindrical with a pair of opposite recess 148 and the base portion 140 has exterior thread 150. The recesses 148 may be used to receive the user's fingers during handling. The exterior thread 150 may be used when attaching to a coupler or a rod with female thread.

Referring to FIG. 8C, another embodiment of a rod holder 152 is disclosed. The rod holder 152 is similar to the rod holder 146, except that the opening 49 in the head portion 138 is angled with respect to the opening 49 in the base portion 140.

The holders 136, 146 are 152 are preferably made of plastic or other suitable materials to advantageously isolate the anchor rod 24 from the ground moisture for protection against corrosion.

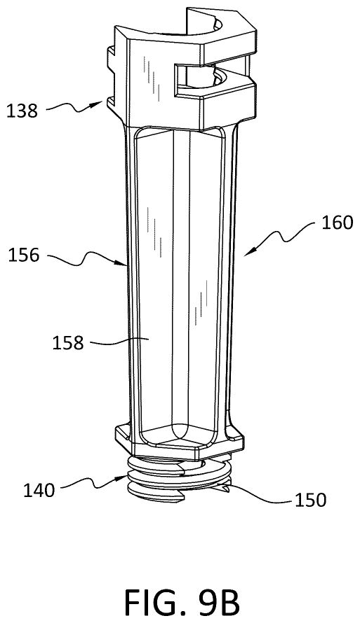

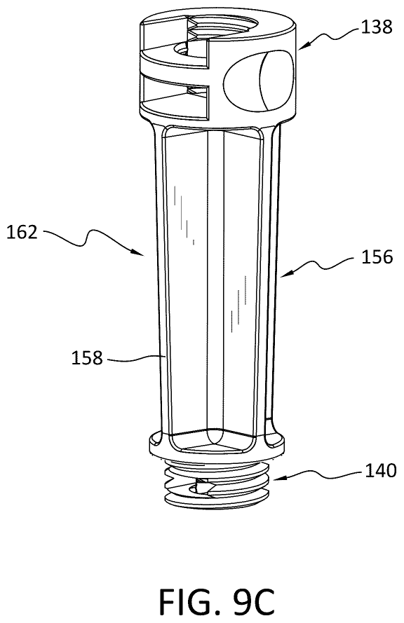

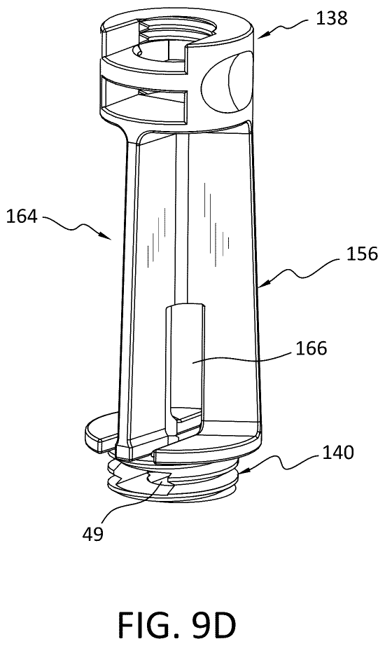

Referring to FIG. 9A, another embodiment of a rod holder 154 is disclosed. The rod holder 154 is similar to the rod holder 136, except that the head portion 138 and the base portion 140 are separated further apart with a support portion 156. The support portion 156 is preferably made of longitudinal flat members 158 forming a cross or X-shape in cross-section. The support portion 156 may be used to elevate the head portion 138 further above the ground on which the base portion 140 is located. Thus, the support portion 158 advantageously provides separation distance between the head portion and the base portion for corrosion protection. The base portion 140 has internal thread 159.

Referring to 9B, another embodiment of a rod holder 160 is disclosed. The rod holder 160 is similar to the rod holder 154, except that the base portion 140 is provided with exterior thread 150.

Referring to FIG. 9C, another embodiment of a rod holder 162 is disclosed. The rod holder 162 is similar to the rod holder 160, except that the head portion 138 is the same as the head portion 138 of the rod holder 146. The base portion 140 is the same as the base portion 140 of the rod holder 146.

Referring to FIG. 9D, another embodiment of a rod holder 164 is disclosed. The rod holder 164 is similar to the rod holder 162, except that the support portion 156 is provided with an opening 166 that communicates with the opening 49 in the base portion 140 to allow the rod 34 to extend into the support portion 156 to advantageously provide a relatively stronger connection with the rod holder 164, but without compromising the separation distance between the head portion and the base portion for corrosion protection of the rod 24 from the ground.

The holders 154, 160 and 162 are preferably made of plastic or other suitable materials to advantageously isolate the anchor rod 24 from the ground moisture for protection against corrosion.

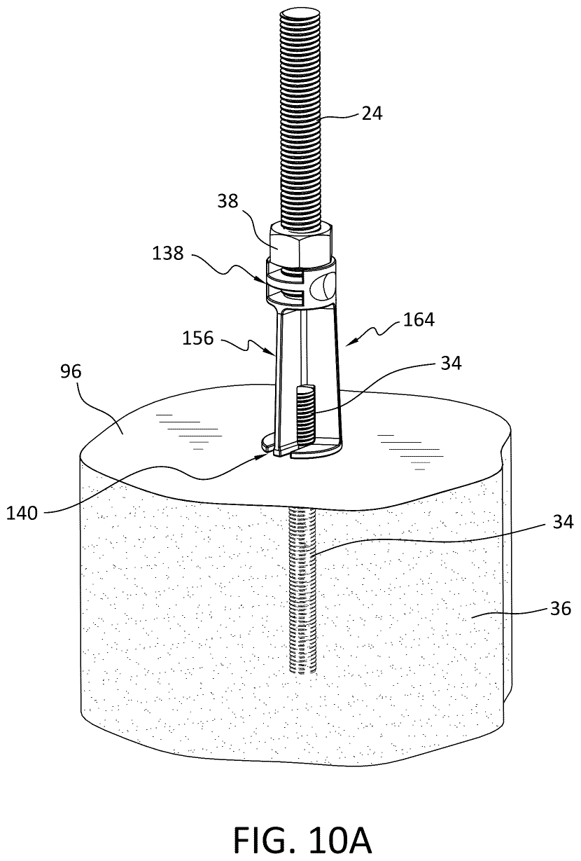

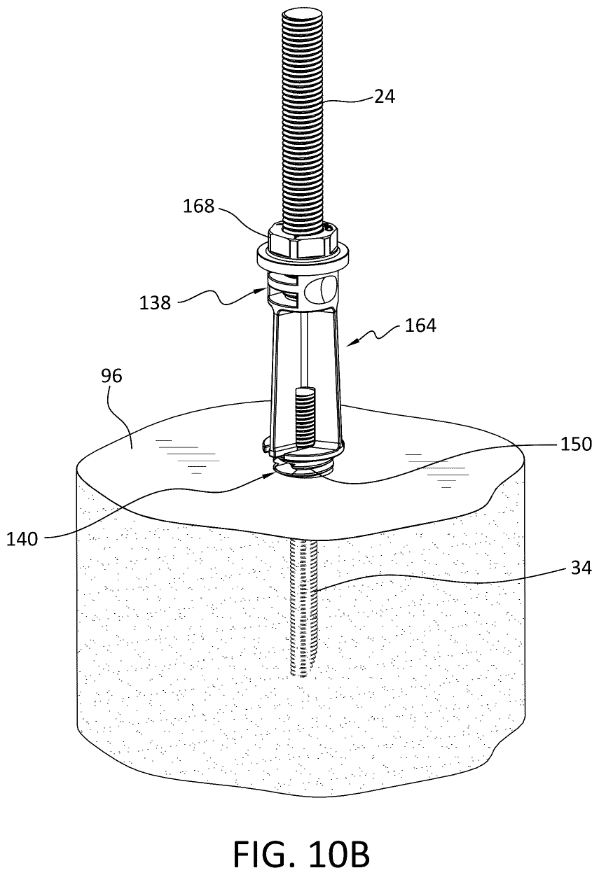

Referring to FIG. 10A, the rod holder 164 is shown installed on the ground 36. The thread 150 of the base portion 140 is disposed below the moisture barrier 96. The rod 34 is threaded to the base portion 140 with one end extending into the support portion 156 and another end being buried in the ground 36. The anchor rod 24 is threaded to the head portion 138 and a nut 38 locks the rod 24 to the head portion 138. The nut 38 also provides the function of an anchor body for creating a shear cone to resist an upwardly directed load on the anchor rod 24. The bottom end of the anchor rod 24 is properly disposed at the correct distance above the ground surface to protect the anchor rod from corrosion. The holder 164 is preferably made of plastic or other suitable materials to advantageously isolate the anchor rod 24 from the ground moisture for protection against corrosion.

Referring to FIG. 10B, the rod holder 164 is shown with the thread 150 of the base portion 140 being disposed above the ground surface. An anchor body 168 is used instead of the nut 38. The anchor body 168 is disclosed in U.S. Pat. No. 11,578,492, incorporated herein by reference. Other anchor bodies may be used as disclosed in U.S. Pat. No. 11,578,492.

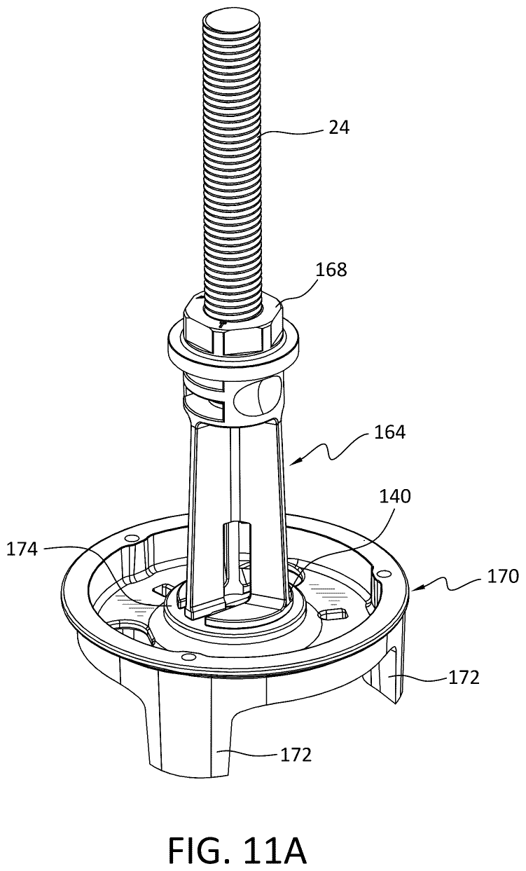

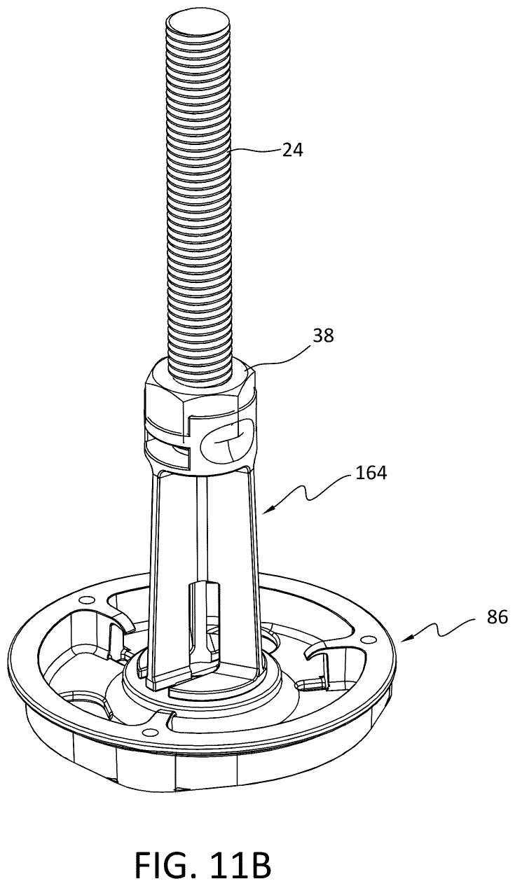

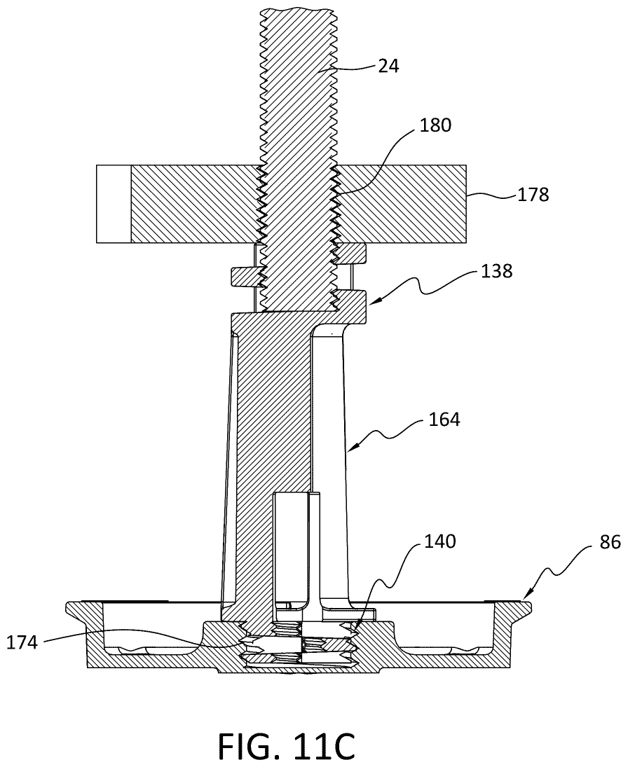

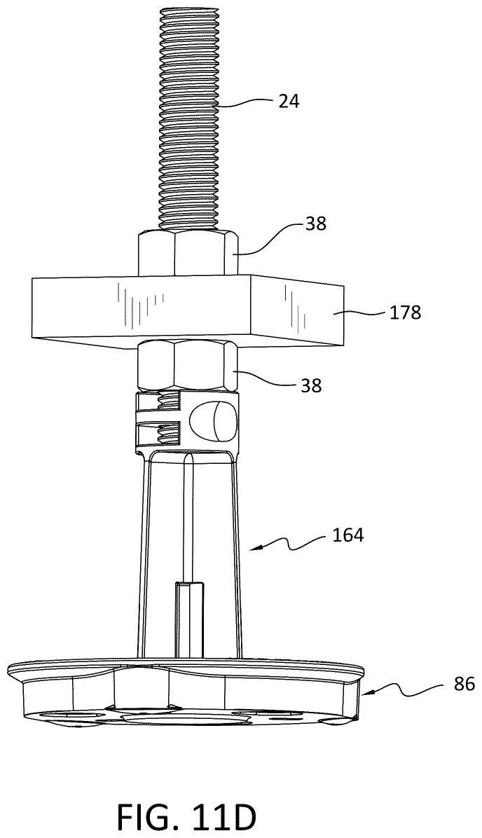

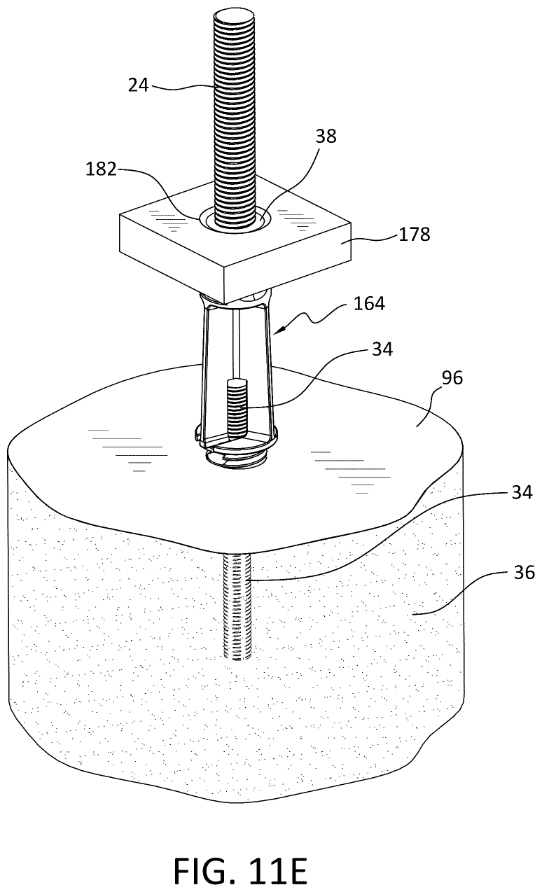

Referring to FIG. 11A, the rod holder 164 is shown attached to a base or holder 170, as disclosed in U.S. Pat. No. 8,943,777, incorporated herein by reference. The base portion 140 is attached to an opening in the holder 170. The exterior thread of he base portion 140 is preferably threaded to an interior thread in the opening of the holder 170. The holder 170 has legs 172 to further elevate the anchor rod 24 and anchor body 168 above the ground or the formboard. The holder 170 has a threaded opening 174 (see FIG. 11C) into which the base portion 140 is threaded. The holder 164 and the base 170 are preferably made of plastic or other suitable materials to advantageously isolate the anchor rod 24 from the ground moisture for protection against corrosion.

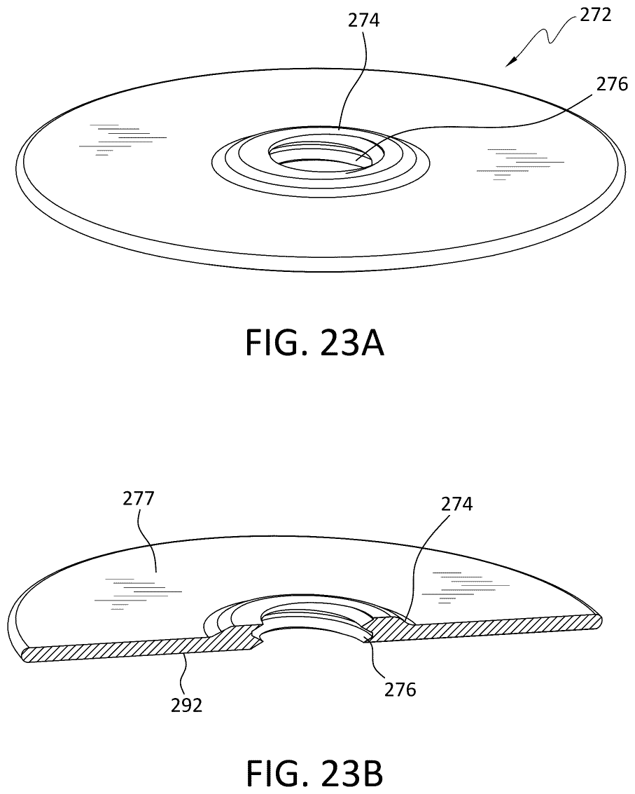

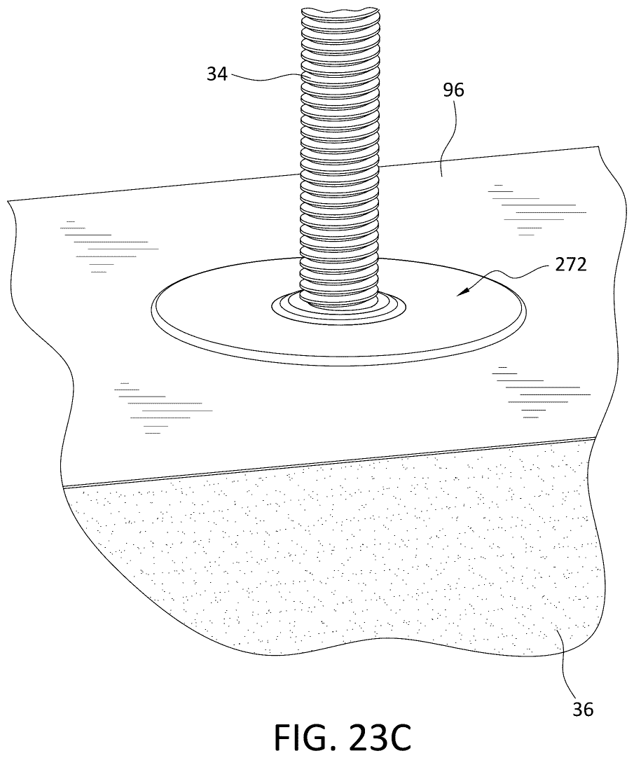

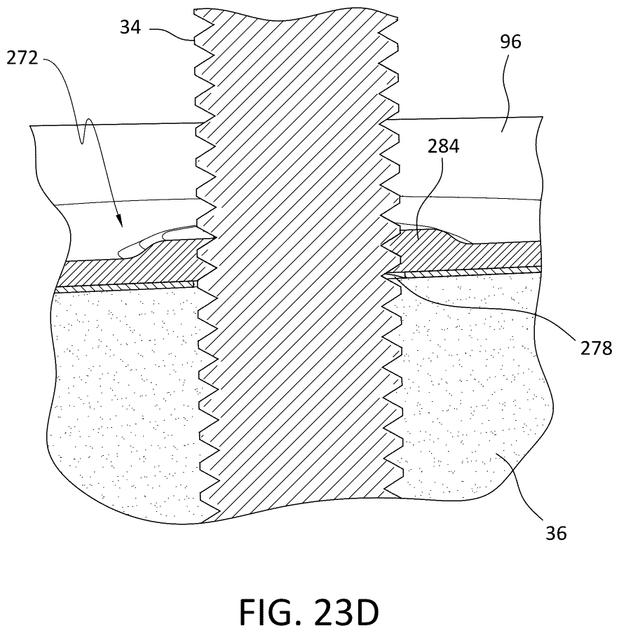

Although not shown, the assembly in FIG. 11A may be disposed on the ground 36 covered with the moisture barrier 96. One of the sealing members 272, 280 and 288 (FIGS. 23A, 24A and 25A) may be interposed between the moisture barrier 96 and the bottom of the leges 172 to seal the puncture holes in the moisture barrier made by the nails driven through the holes in the legs 172 when attaching the holder 170 to the ground.

Referring to FIG. 11B, the rod holder 164 is attached to a base or holder 86 similar to the holder 170, except that the legs 172 are not used. The holder 176 has a flat bottom for placement on the ground or formboard. The holder 86 is also disclosed in U.S. Pat. No. 8,943,777.

Referring to FIG. 11C, the assembly shown in FIG. 11B is shown in cross-section, with the nut 38 being replaced by a metal plate 178 with a threaded opening 180. The metal plate 178 advantageously provides a larger bearing surface for creating a shear cone when the anchor rod 24 is subjected to an upwardly directed load.

Referring to FIG. 11D, the metal plate 178 is modified where the opening 180 is unthreaded. Nuts 38 are used to attach the metal plate 178 to the anchor rod 24.

It should be understood that the assemblies in FIGS. 11B-11D may be attached to the moisture barrier 96 with the same means disclosed in FIGS. 5A-7D. The holder 86 shown in FIGS. 11B-11D may be interchanged with the holders 106 and 124 shown in FIGS. 6A-7D.

Referring to FIG. 11E, the metal plate 178 is further modified wherein the nut 38 is welded to the metal plate 178. The nut 38 may be cylindrical and disposed in the opening 182. The rod holder 164 is attached to the ground 36 in the same way as shown in FIG. 10B.

It should be understood that the holder 164 shown in FIGS. 11A-11E may be interchanged with the holders 154, 160 and 162 shown in FIGS. 9A-9C.

It should be understood that the holder 164 when attached to the holder 170 or 86, as shown in FIGS. 11A-11D, becomes one unit and functions as one rod holder having a head elevated above a base.

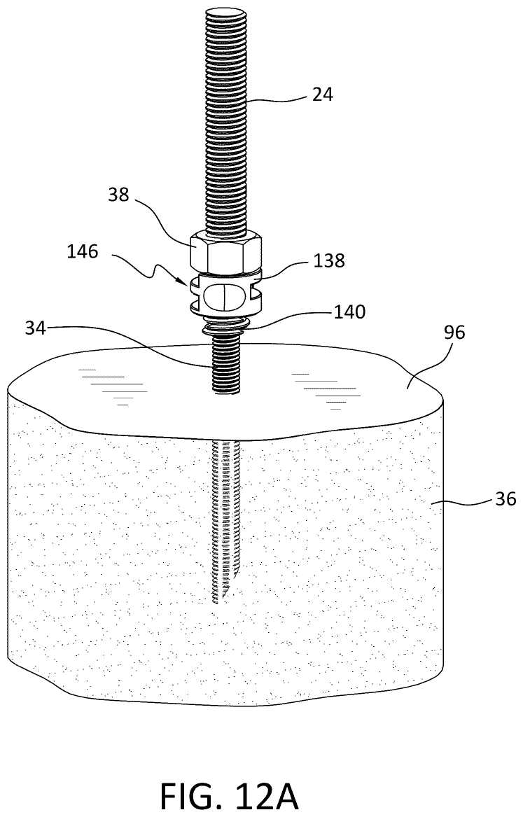

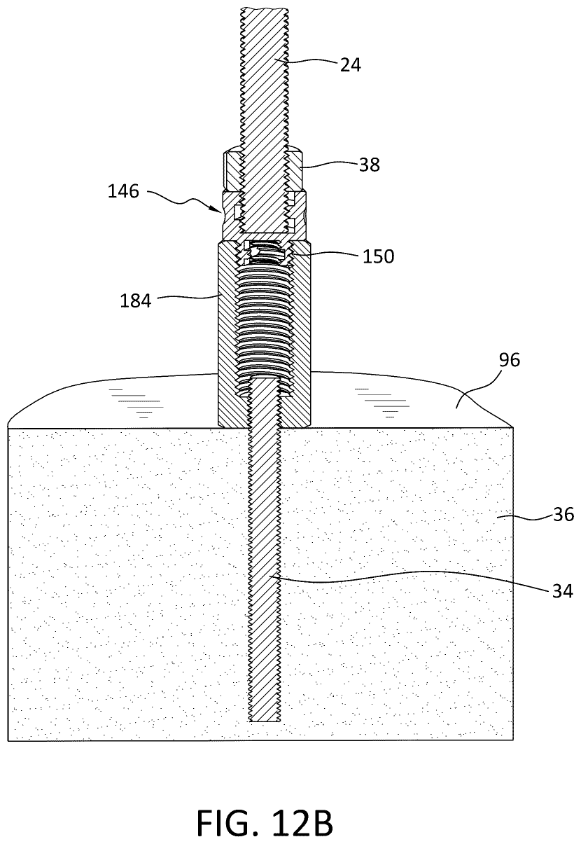

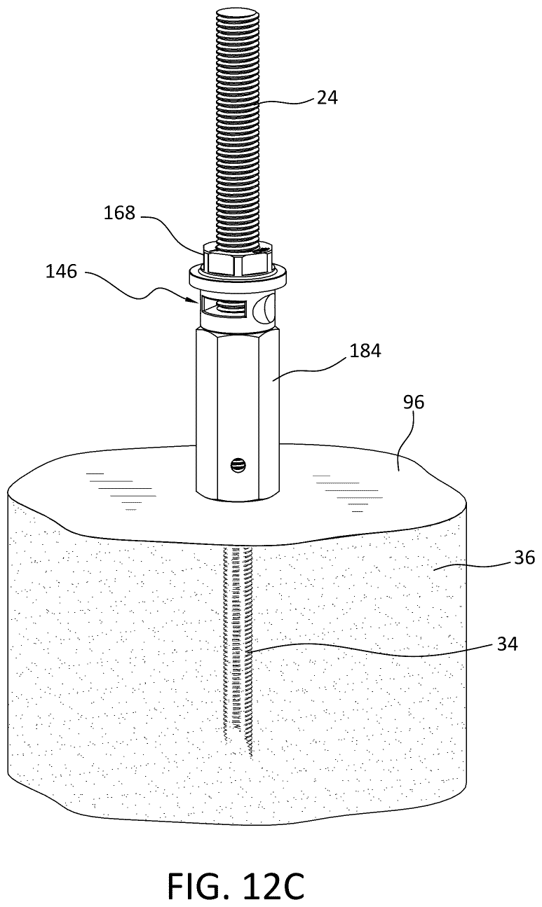

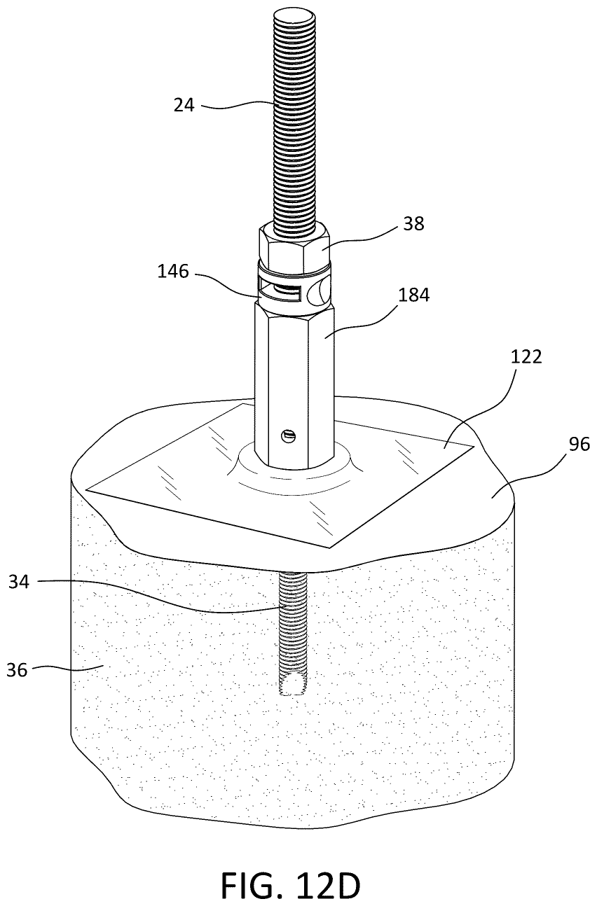

Referring to FIG. 12A, the rod holder 146 is shown positioned above the ground 36 by means of the rod 34 attached to the base portion 140 via the internal thread 159. The rod 34 is driven to the ground as a stake. The anchor rod 24 is attached to the head portion 138. The rod 34 is preferably smaller in diameter than the anchor rod 24 since the rod 34 is merely used as a stake. The coupler 146 is advantageously located above the vapor barrier 96 at a distance above the ground 36 to protect the anchor rod 24 from corrosion.

Referring to FIG. 12B, a coupler 184 at its upper end is threaded to the thread 150 of the base portion 140 of the rod holder 146. The coupler 184 may be made of metal. The bottom end of the coupler 184 is threaded to the rod 34. A nut 38 acts as an anchor body and at the same time locks the anchor rod 24 to the rod holder 146. The rod holder 146 advantageously isolates the nut 38 and the anchor rod 24 from the coupler 184 and the rod 34 for corrosion protection of the nut 38 and the anchor rod 24. The coupler 184 may also be made of plastic for corrosion protection of the rod 24.

Referring to FIG. 12C, the nut 38 is replaced by the anchor body 168.

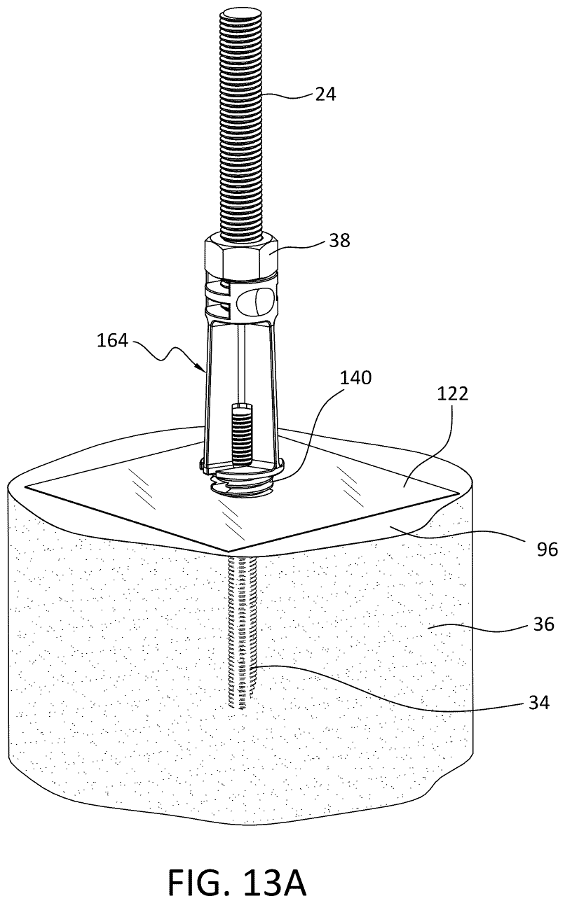

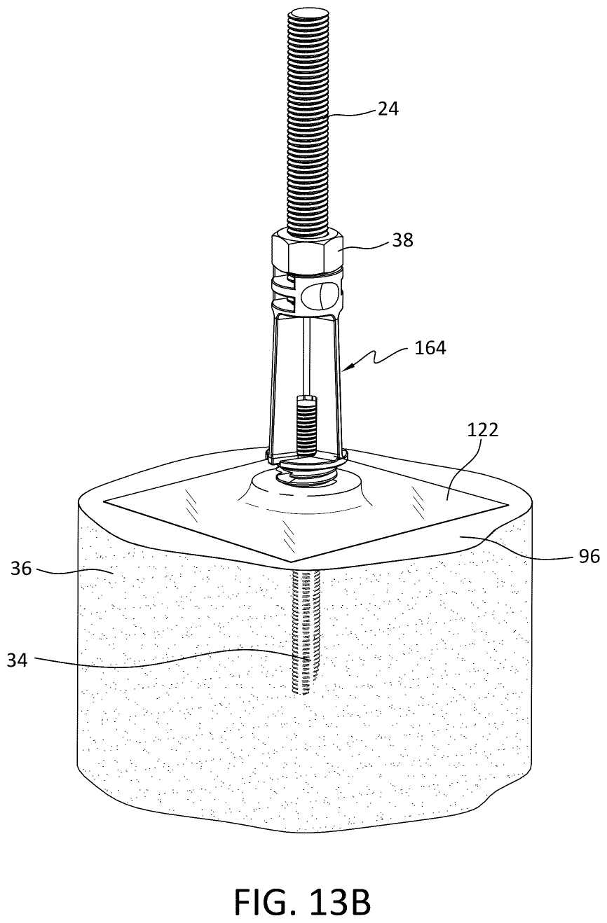

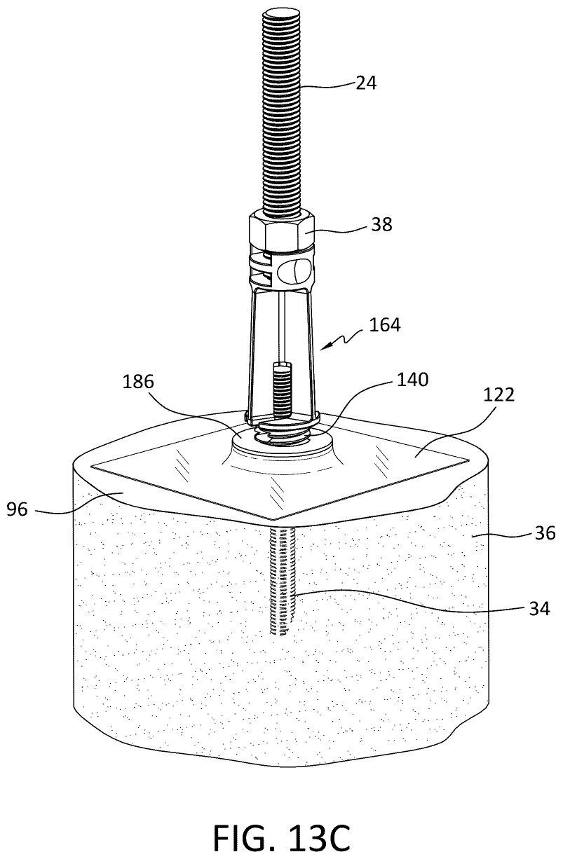

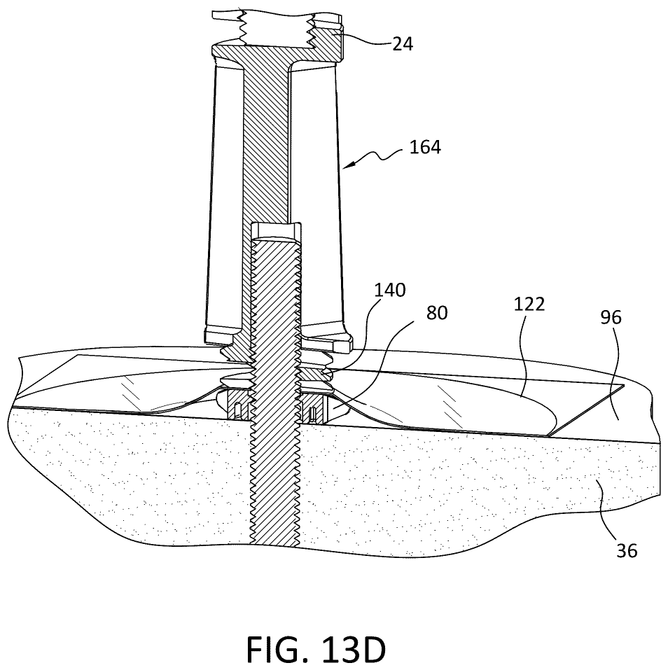

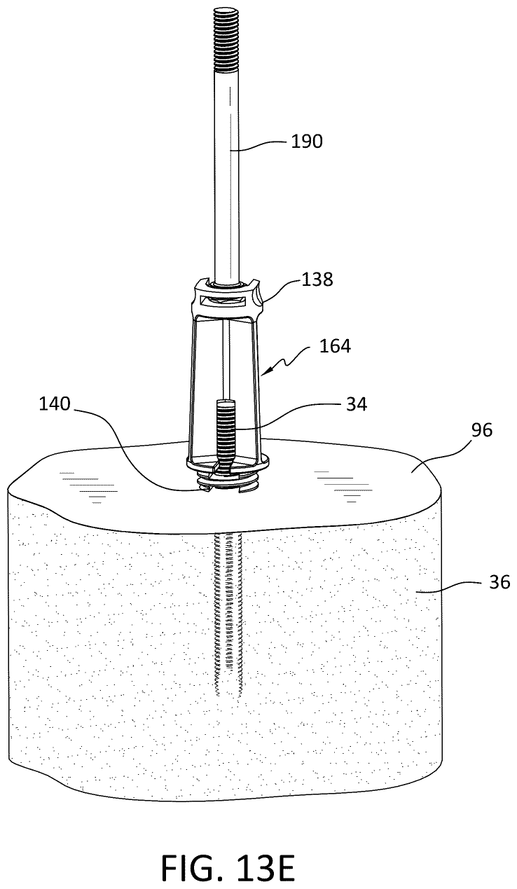

Referring to FIG. 12D, a washer 186 (see FIG. 13C) underneath the adhesive tape operably bears on the bottom end of the coupler 184. A plastic nut 80 (FIG. 13D) is attached to the rod 34 and locks the washer to the coupler 184. The washer and the nut are disposed under the adhesive tape 122 and above the vapor barrier 96 to advantageously seal the penetration of the moisture barrier 96 by the ground rod 34. Sealing the penetration opening ensures that moisture from the ground cannot migrate to the concrete through the penetration, thus protecting the anchor rod 24, the hex nut 38, the rod holder 146 and coupler 184 from corrosion. See FIG. 13C for the washer 186 and FIG. 13D for the plastic nut 80.

Although the assemblies in FIGS. 12A-12D are only shown with the holder 146, it should be understood that the other holders 136 and 138 may also be used.

Referring to FIG. 13A, the rod holder 164, the base portion 140 of the rod holder 164 is disposed a distance above the adhesive tape 122.

Referring to FIG. 13B, a washer 186 (see FIG. 13C) engages the bottom of the base portion 140. A nut 80 (see FIG. 13D) locks the washer and the rod 34 to the rod holder 164. The washer and the nut are disposed below the adhesive tape and above the vapor barrier 96 to advantageously seal the penetration of the moisture barrier 96 by the rod 34.

Referring to FIG. 13C, a washer 186 engages the bottom of the base portion 140 and is disposed above the adhesive tape. Another washer 186 (hidden from view) is disposed below the adhesive tape to sandwich the adhesive tape between the two washer 186. A nut 80 (see FIG. 13D) shown) secures the washers and the rod 34 to the rod holder 164.

Referring to FIG. 13D, a plastic nut 80 or a hex nut 79 secures the rod 34 to the rod holder 164. The nut 80 or the hex nut 9 is disposed under the adhesive tape and above the vapor barrier 96 to advantageously seal the penetration of the moisture barrier 96 by the ground rod 34. Sealing the penetration opening ensures that moisture from the ground cannot migrate to the concrete through the penetration opening, thus protecting the anchor rod 24 and the hex nut 38 from corrosion. A standard hex nut 38 may also be used.

It should be be understood that the plastic nut 80 or the hex nut 79 may also be disposed underneath the moisture barrier 96 to sandwich both the moisture barrier 96 and the adhesive tape 122 to the base portion 140.

Referring to FIG. 13E, a hex bolt 190 may be used as the anchor rod 24. The hex bolt 190 has a threaded head threaded to the head portion 138. The bolt 190 advantageously combines the functions of the nut 38 and the anchor rod 24.

Although the assemblies in FIG. 13A-13E are shown with the holder 164, it should be understood that the other holders 154, 160 and 162 may also be used.

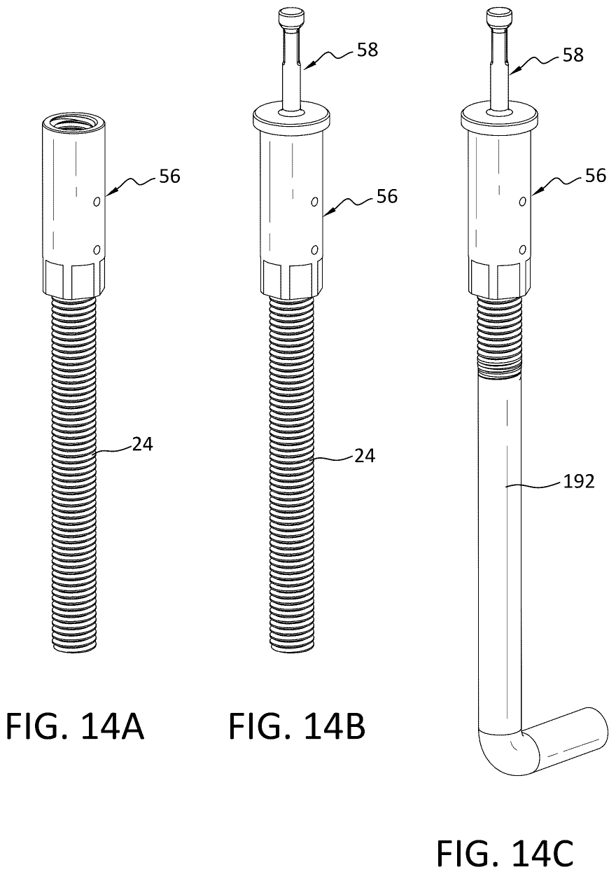

Referring to FIG. 14A, the anchor rod 24 is shown attached to the coupler 56.

Referring to FIG. 14B, a plug 58 for sealing the open end of the coupler 56 is shown.

Referring to FIG. 14C, an L-shaped anchor rod 192 replaces the anchor rod 24. The anchor rod 192 provides the anchorage function with using an anchor body, such as the hex nut 38 or the anchor body 168.

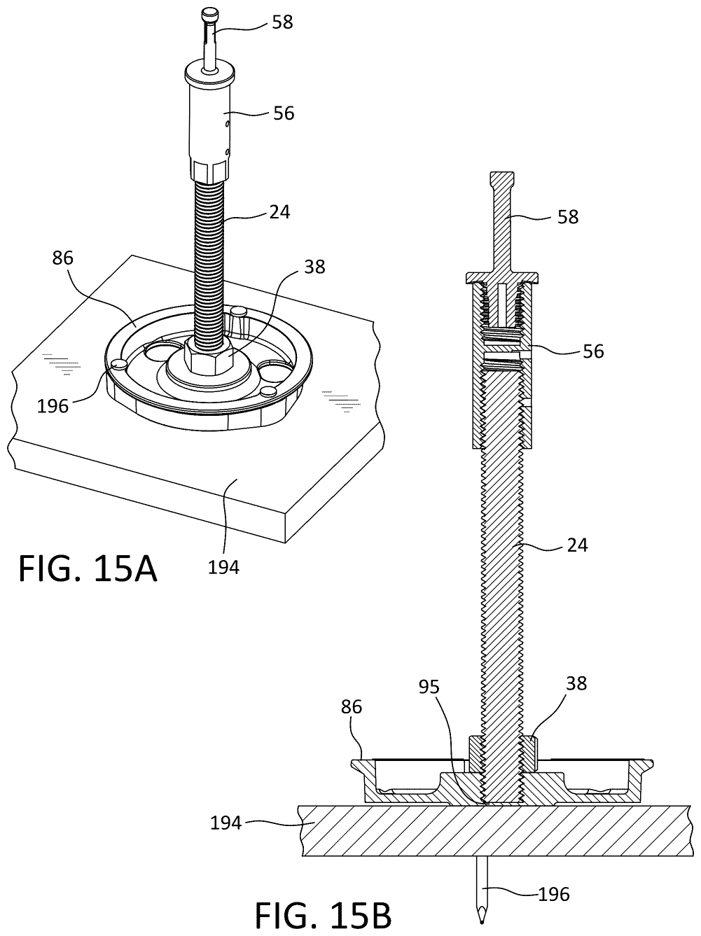

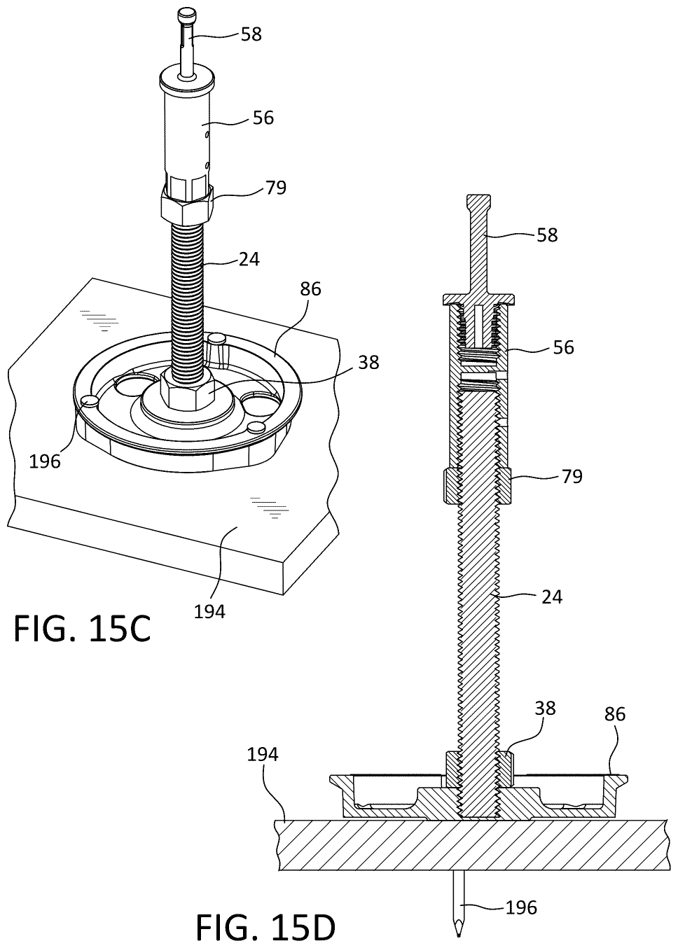

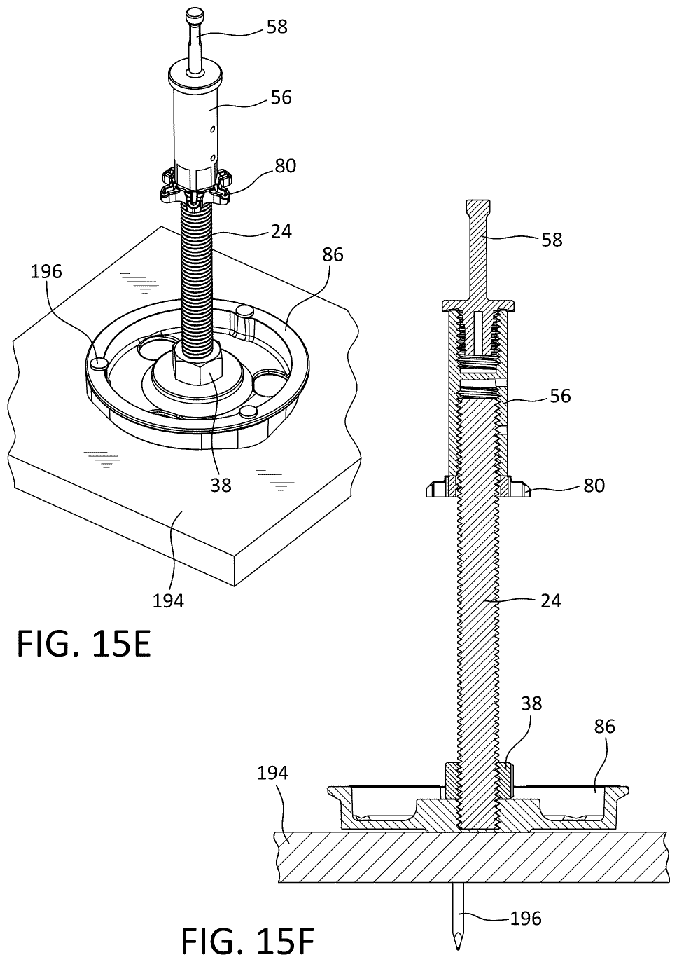

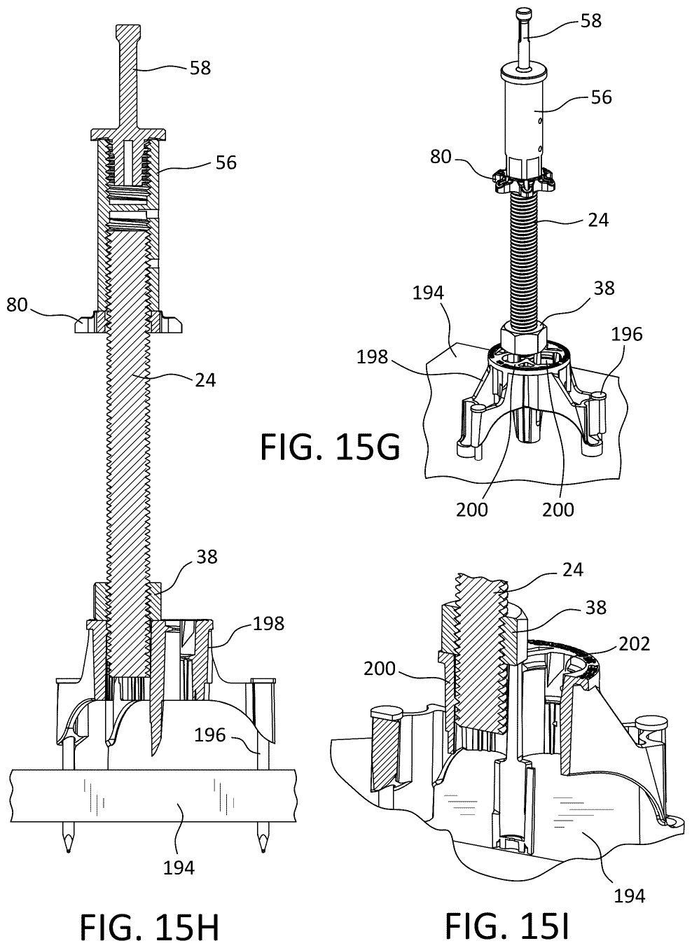

Referring to FIGS. 15A and 15B, a rod holder 86 is shown attached to a formboard 194 with nails 196 and/or screws. The formboard 194 forms a concrete form surface. The nut 38 secures the anchor rod 24 to the rod holder 86 and provides the anchorage function of an anchor body. The formboard 194 is used to form a concrete structure above ground, such as a concrete beam. The bottom of the anchor rod 24 is isolated from the environment after the formboard is removed with the bottom wall 95.

Referring to FIGS. 15C-15D, a nut 79 is used to lock the anchor rod 24 to the coupler 56 after the coupler has been adjusted to the required height.

Referring to FIGS. 15E-15F, the nut 79 may be replaced with a plastic nut 80.

Referring to FIGS. 15G-15I, a rod holder 198 is used to attach the anchor rod 24 to the form board 194. The rod holder 198 has a threaded opening 200 with thread 202 that allows height adjustment of the anchor rod 24. The rod holder 198 has multiple threaded openings 200 with different diameters to advantageously accommodate use of different size rods. The holder 198 is preferably made of plastic or other suitable materials to advantageously isolate the anchor rod 24 from the environment for protection against corrosion. The rod holder 198 is disclosed in nonprovisional application Ser. No. 18/196,477, filed May 12, 2023, hereby incorporated by reference.

Referring to FIGS. 16A-16B, the anchor rod 24 is shown attached to a rod holder 202 similar to the rod holder 198, except that the rod holder 202 has a single opening for the anchor rod 24. The holder 202 is preferably made of plastic or other suitable materials to advantageously isolate the anchor rod 24 from the environment after the formboard 194 is removed. The rod holder 202 also provides vertical adjustability to the anchor rod 24, as disclosed in nonprovisional application Ser. No. 18/196,477, filed May 12, 2023. The assembly is shown embedded in a concrete structure 81 with a top surface 206. The plug 58 is shown removed from the coupler 56 after the concrete has been cured. The top surface of the flange portion 60 is preferably level with the top surface 62 so that the top edge 204 of the coupler 56 is disposed below the top surface 206 of the concrete structure 81.

Referring to FIGS. 16C-16E, the plug 58 is modified as plug 206 having a flange portion 208 with a top surface 210 which is configured to align at the same level as the top edge 204 of the coupler 56. When embedded in concrete, the top edge 204 of the coupler 56 and the top surface 210 of the flange portion 208 of the plug 206 are preferably at the same level as the top surface 62 of the concrete structure 81.

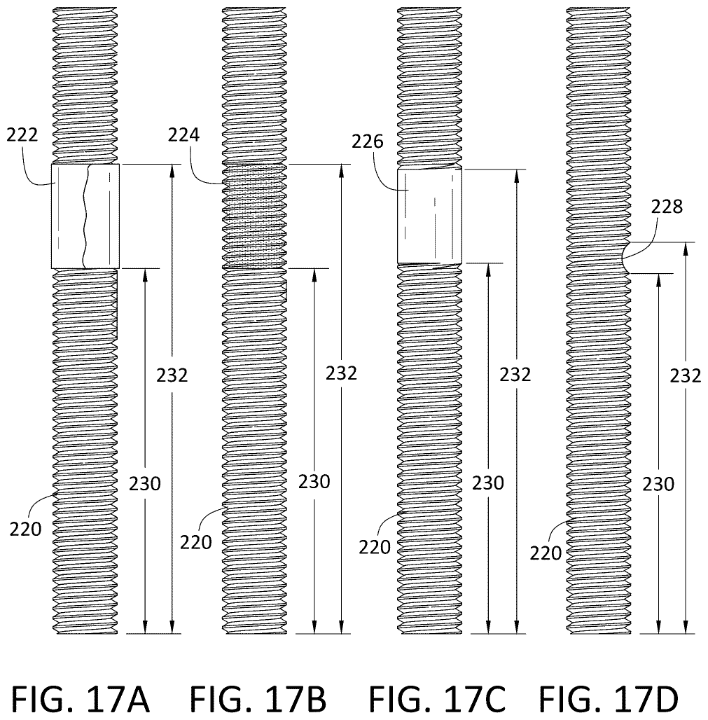

Referring to FIGS. 17A-17D, a tie rod 220 may have a reference point, such as a tape wrap 222, paint or dye marking 224, nonthreaded portion 226, a notch or deformation 228, or the terminal end of the rod. The reference points on the tie rod are used in ascertaining that the minimum thread engage of the tie rod 220 with the coupler 56 is achieved. Each of the reference points has a known dimension 230 from the bottom end of the tie rod 220 to the bottom edge of the marking, or a known dimension 232 to the top edge of the marking.

Referring to FIGS. 18A-18B, the minimum thread engagement of the tie rod 220 with the coupler 56 has a known dimension 234. A measuring tape 236 may be used to verify the minimum thread engagement of the tie rod 220 with the couple 56 embedded in the concrete structure 81. The distance of the tape 222 to the bottom end of the tie rod 220 is known before installation, such as from actual measurement, shop drawings or other sources. The minimum thread engagement is also a known distance from the top surface of the concrete structure 81 to the bottom end of the tie rod 220. When the distance 235 of the tape 222 is measured above the top surface 62 of the concrete structure 81, a building inspector will be able to determine if the tie rod 220 has the minimum thread engagement with the coupler 56. The distance 235 should be the distance 230 minus the distance 234. Accordingly, the markings 222, 224, 226 or 228 advantageously provides a way of verifying the minimum thread engagement of the tie rod 220 with the coupler 56.

Referring to FIGS. 18C-18D, a base plate 238 for a stud wall is disposed on the top surface 62. After measuring the thickness 237 of the base plate 238, the distance 239 from the top of base plate to the marking such, as the painted marking 234, should equal to the distance 230 minus the distance 237 minus the distance 234. The distance 239 will advantageously provide verification if the tie rod has minimum thread engagement with the coupler 56.

Referring to FIGS. 18E-18F, the use of the markings 226 and 228 is illustrated with the bottom plate 238 in place. It should be understood that the any of the markings, such as the tape wrap 222, the painted marking 224, smooth surface 236 and the notch 228 equally applicable in any situation, whether there is a base plate 238 or not, verifying the minimum thread engagement of the tie rod 220 with the coupler 56.

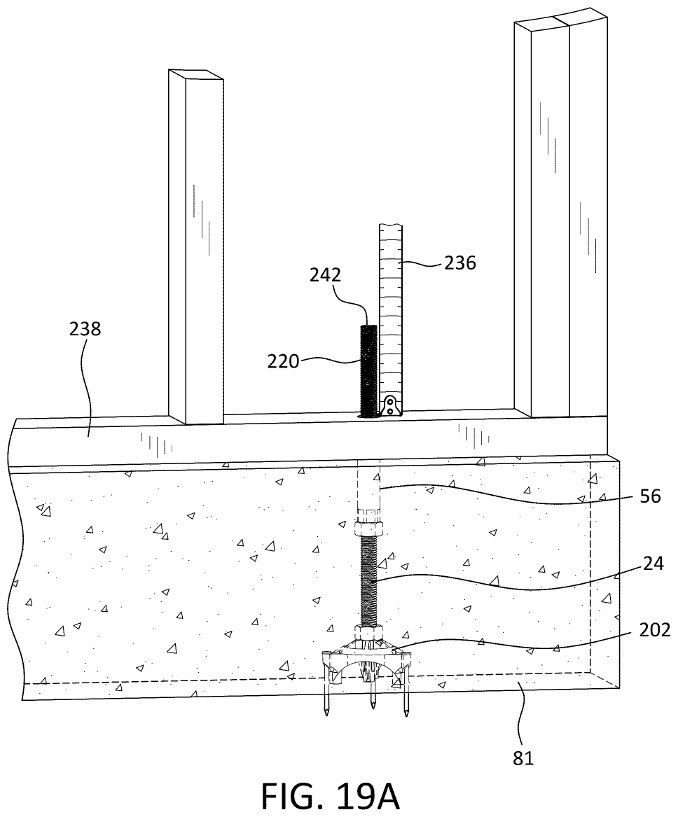

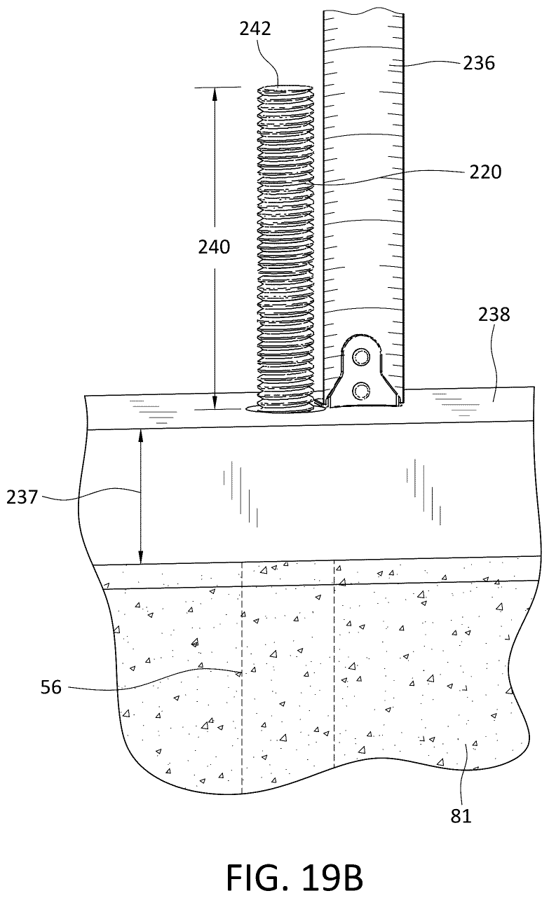

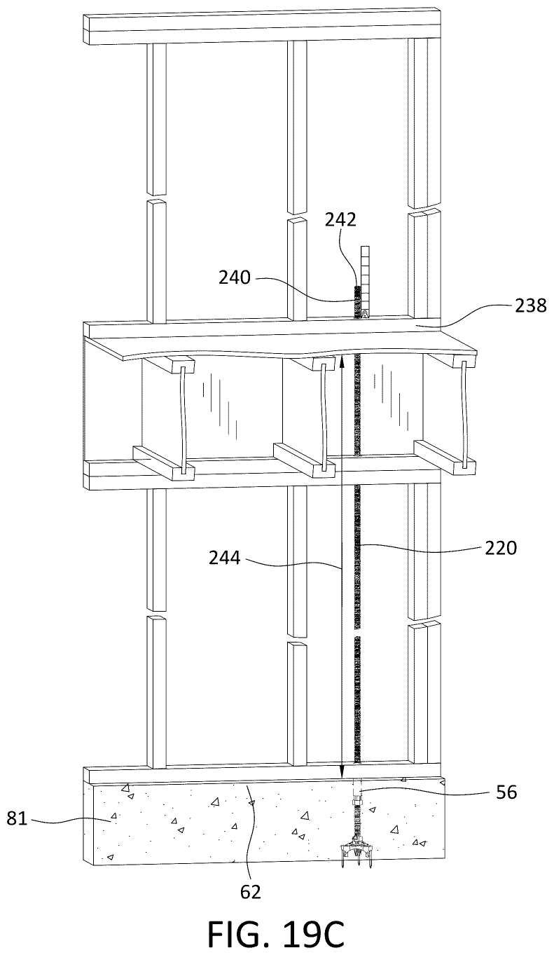

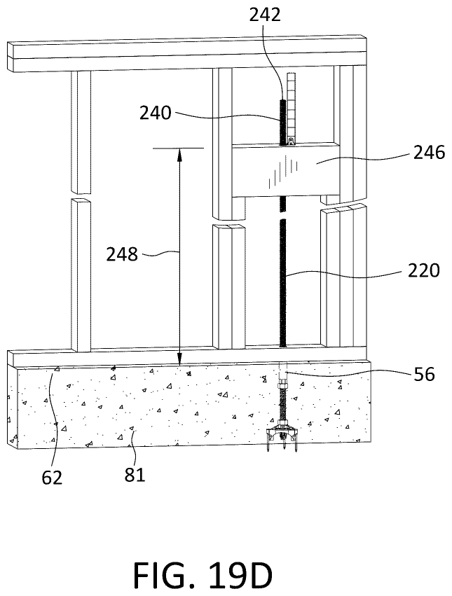

Referring to FIGS. 19A-19D, the top end 240 of the tie rod 220 may be used as a reference point, in lieu of the markings on the tie rod, to verify the minimum thread engagement with the coupler 56. The length of the tie rod 220 prior to installation is known.

Referring to FIGS. 19A-19B, the distance 240 from the top of the bottom plate 238 to the top end 242 of the tie rod 220 provides verification of the minimum thread engagement of the tie rod 220 with the couple 56. The distance 240 should equal to the length of the tie rod prior to installation minus the thickness 237 of the bottom plate 238 minus the distance 234 of the minimum thread engagement. The distance 240 is verifiable by the building inspector with a tape measure 236.

Referring to FIG. 19C, the tie rod 220 terminates above the second floor bottom plate 238. The length of the tie rod 220 prior to installation may be specified in the shop drawings, by actual measurement or other sources. The distance 244, which is the distance from the top surface of the bottom plate 238 to the top surface 62 of the concrete structure 81 may be specified in the shop drawings, by actual measurement or known from other sources. The distance 240 should be equal to the length of the tie rod 220 minus the distance 234 minus the distance 244 to confirm minimum thread engagement of the tie rod 220 with the coupler 56. The distance 240 may be specified prior to installation, such as in the shop drawings, and verified in the field.

Referring to FIG. 19D, the tie rod 220 terminates above a cross member 246. The length of the tie rod 220 is known. The distance 248 of the top of the cross member 246 from the top surface 62 of the concrete structure 81 is also known. The distance 240 from top end 242 of the tie rod 220 to the top surface of the cross member 246 should equal to the length of the tie rod 220 minus the distance 234 minus the distance 244. The distance 240 may be specified prior to installation, such as in the shop drawings, and verified in the field.

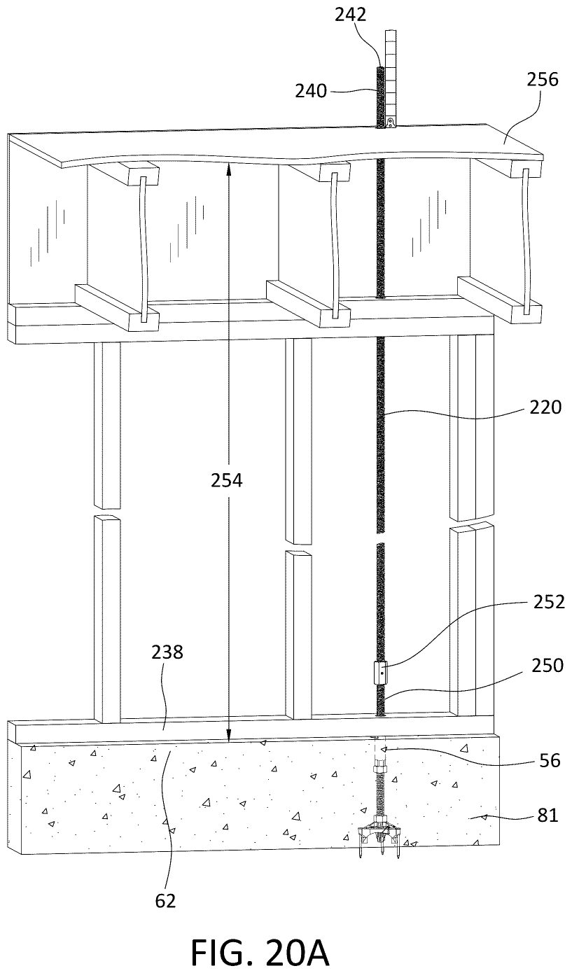

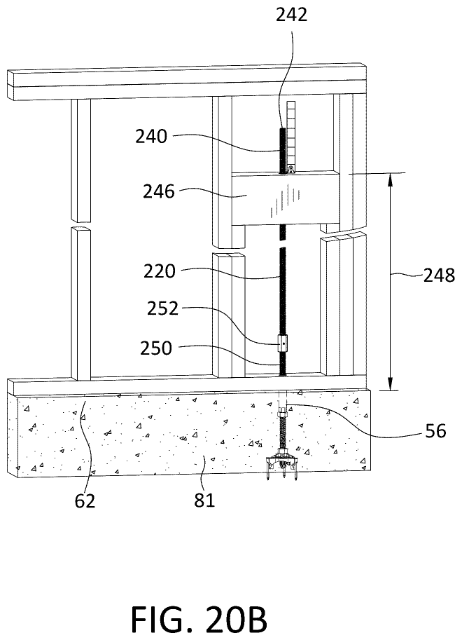

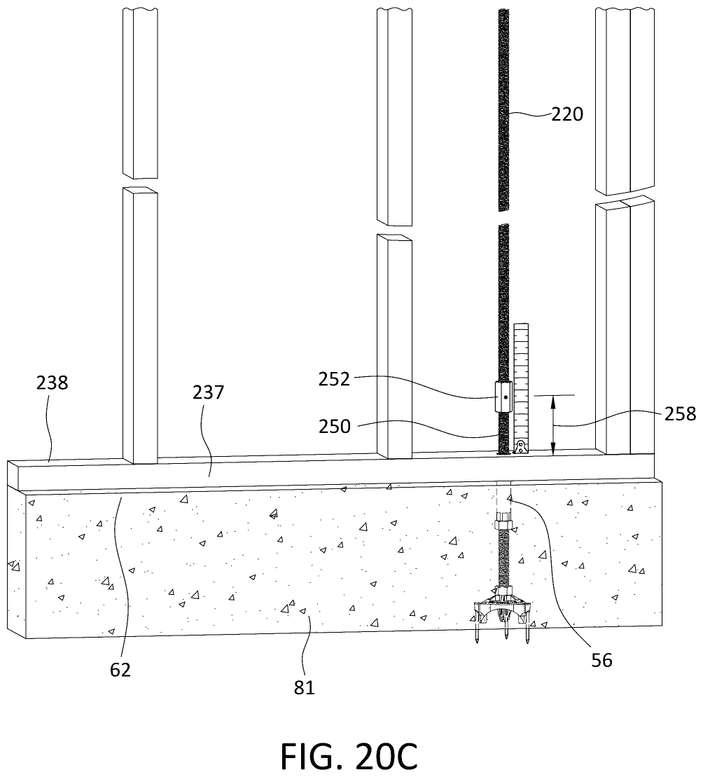

Referring to FIG. 20A, the tie rod 220 terminates above the subfloor 256 in the second floor. The tie rod 220 is attached to a another rod 250 via a coupler 252. The combined length of the tie rod 220 with the attached rod 250 may be specified prior to installation from actual measurement, the shop drawings or other sources. The distance 254 of the top of the subfloor 256 above the top surface 62 of the concrete structure 81 may be specified from the shop drawings, by actual measurement or other sources. Accordingly, the distance 240 of the top end 242 of the tie rod 220 above the subfloor 256 should be equal to the combined length of the tie rod 220 and the rod 250 minus the distance 234 of the minimum thread engagement of the rod with the coupler 56. The distance 240 is measurable to verify that the rod 250 has minimum thread engage with the coupler 56.

Referring to FIG. 20B, the tie rod 220 is terminated above the cross member 246. The combined length of the tie rod 220 and the rod 250 is known. The distance 248 of the top of the cross member 246 from the top surface 62 of the concrete structure 81 is also known. The distance 240 from top end 242 of the tie rod 220 to the top surface of the cross member 246 should equal to the overall length of the combined tie rod 220 and the rod 250 minus the distance 234 minus the distance 244. The distance 240 may be specified before installation, such as in the shop drawings or other sources, and verified in the field to ensure that the combined rod has minimum thread engagement with the coupler 56.

Referring to FIG. 20C, the end of the combined tie rod 220 and the rod 250 may not be available as a reference point for verifying the minimum thread engagement of the combined rod. In this case, measurement may be made from an identifiable feature on the coupler 252, such as the bottom edge, top edge or sight hole. The length of the combined rod 250 with the attached coupler 252 from the bottom of the rod 250 to the identifiable feature of the coupler 252 is known. The distance 258 from the identifiable feature of the coupler 252 to the top surface of the base plate 238 should equal the length of the combined rod 250 with the attached coupler 252 to the identifiable feature minus the thickness 237 of the base plate 238 minus the distance 234 of the minimum thread engagement. The distance 258 is specified and measurable in the field to verify that the rod 250 has minimum thread engagement with the coupler 56.

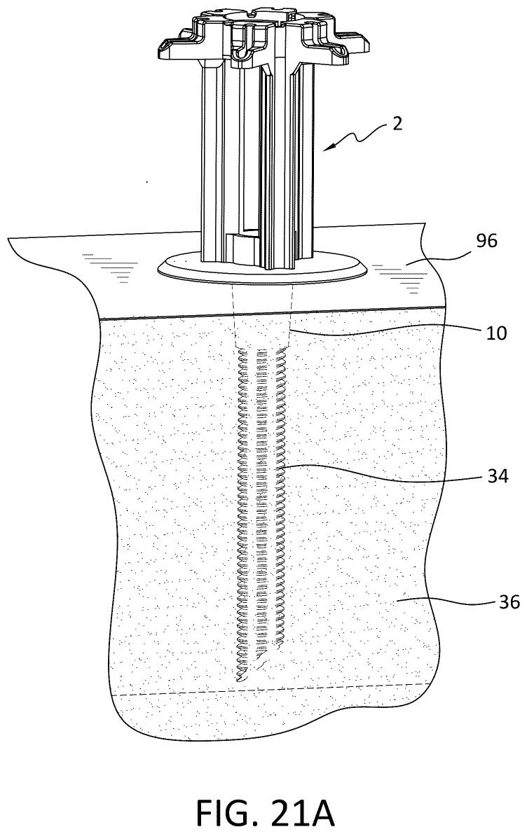

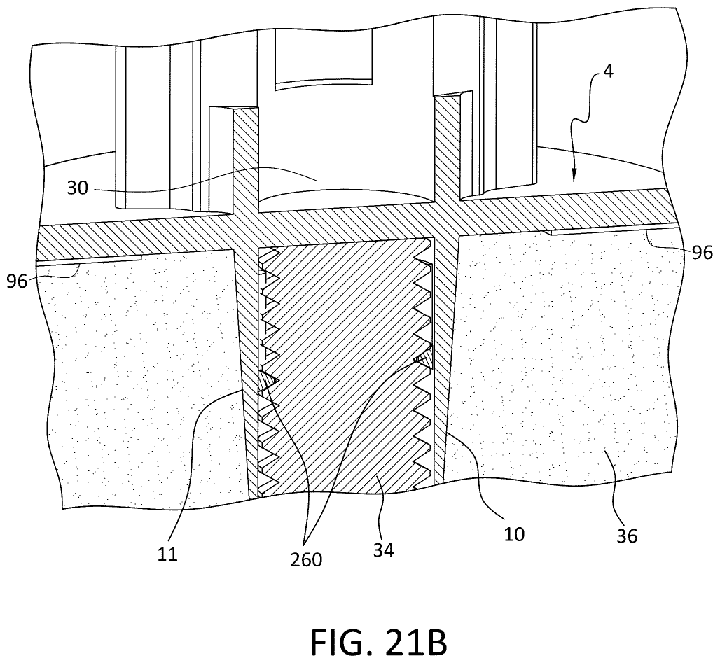

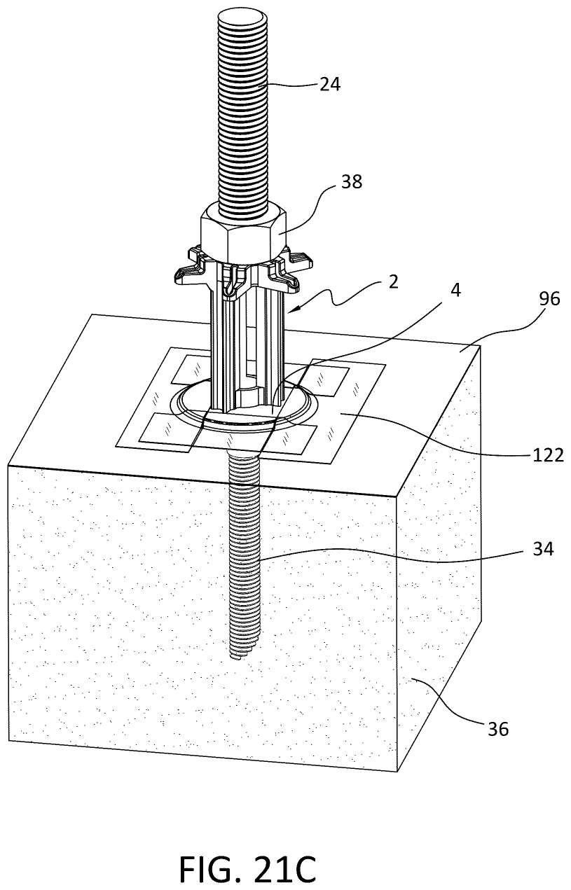

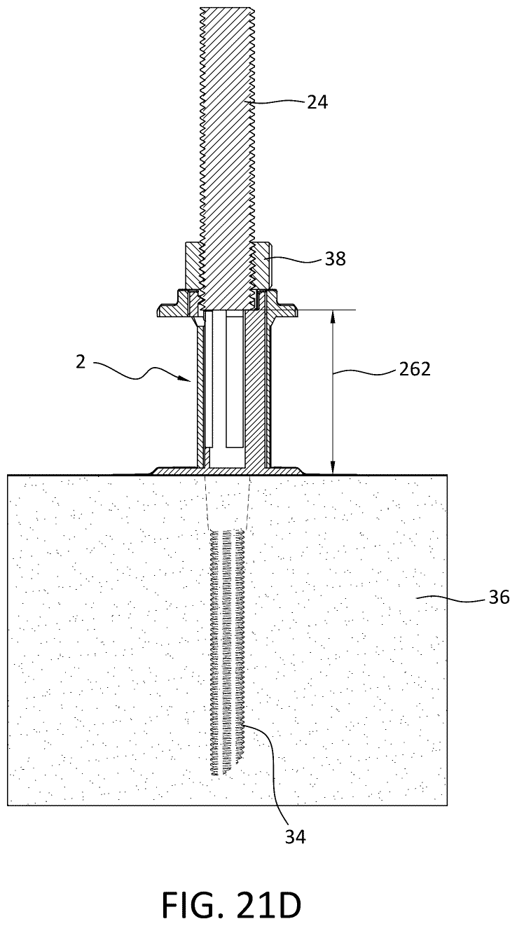

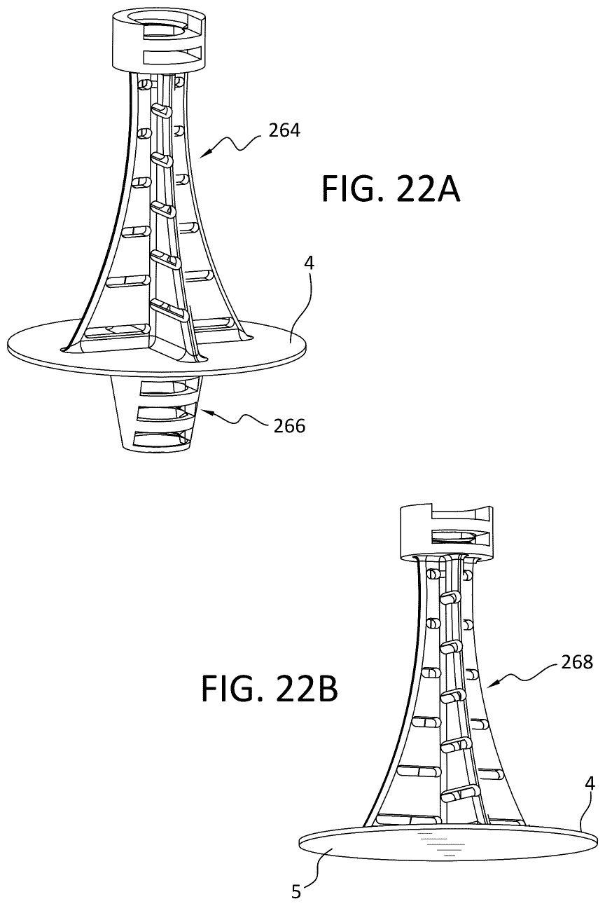

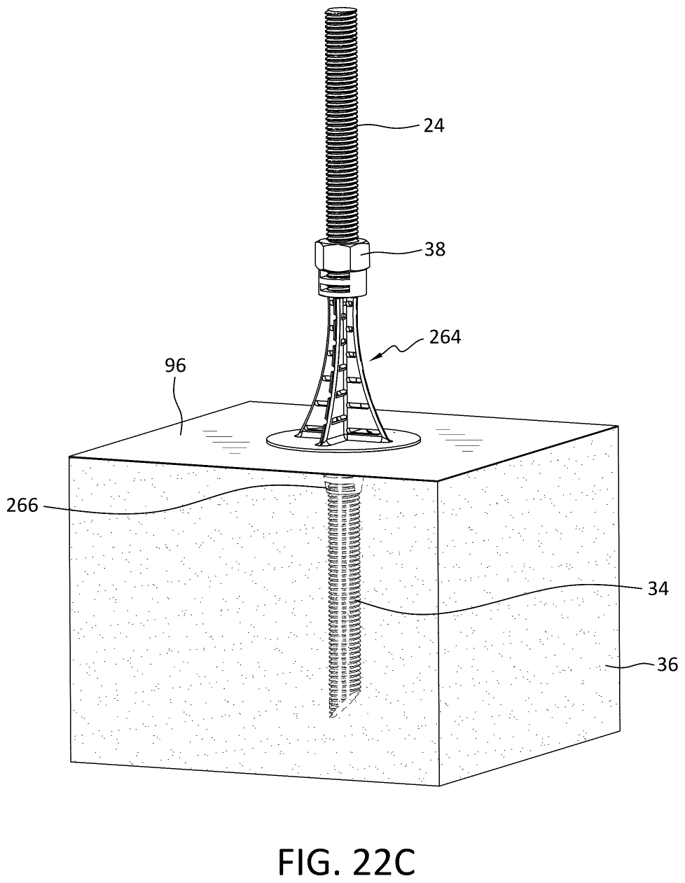

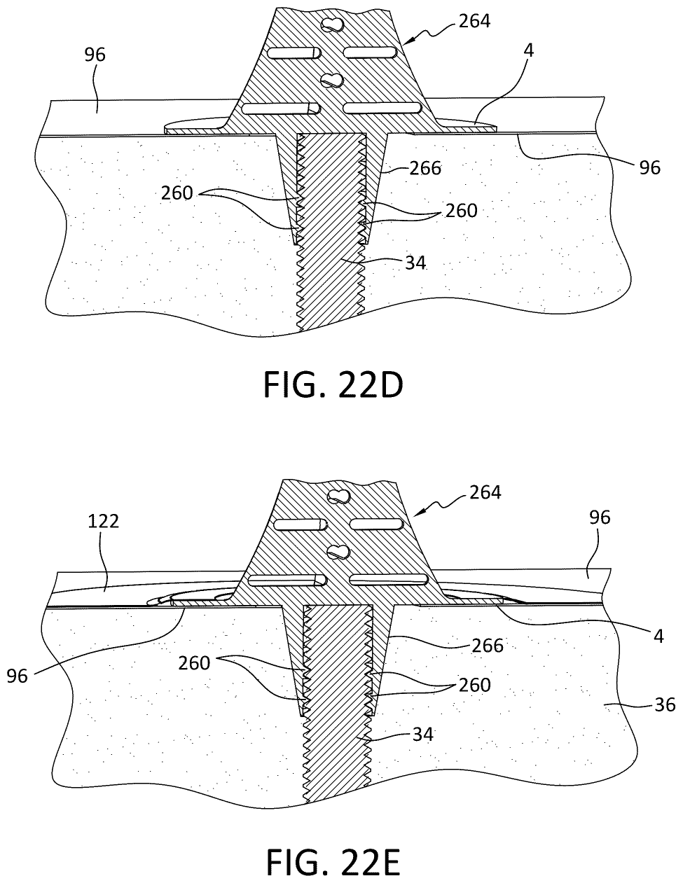

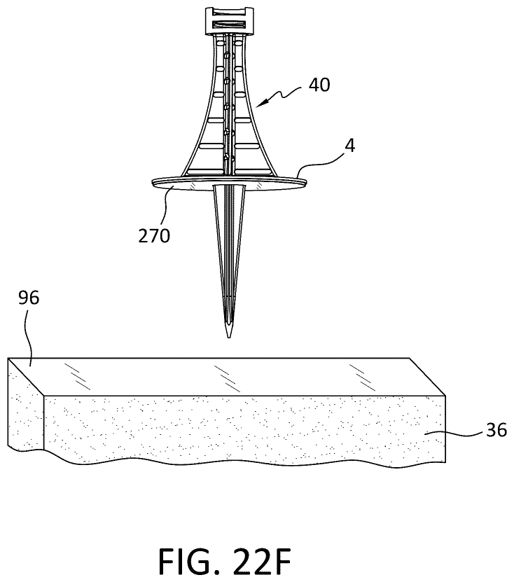

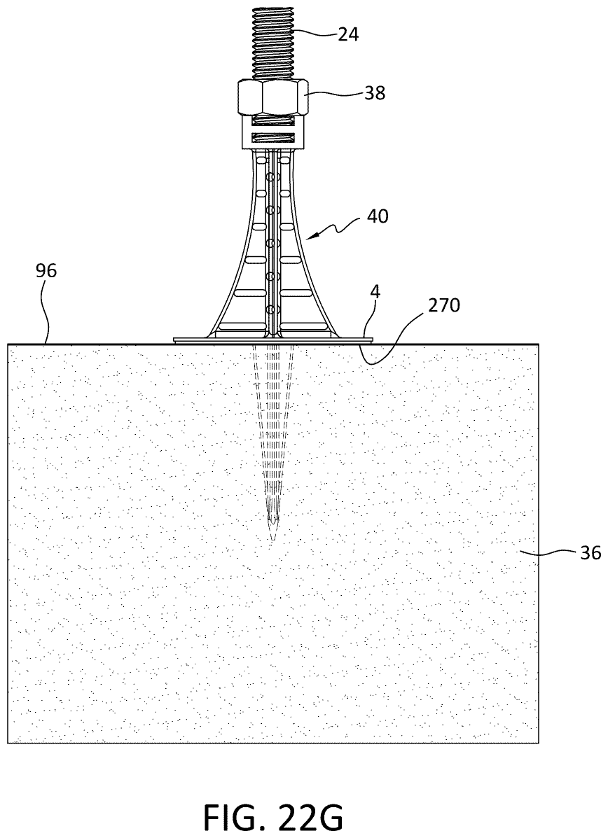

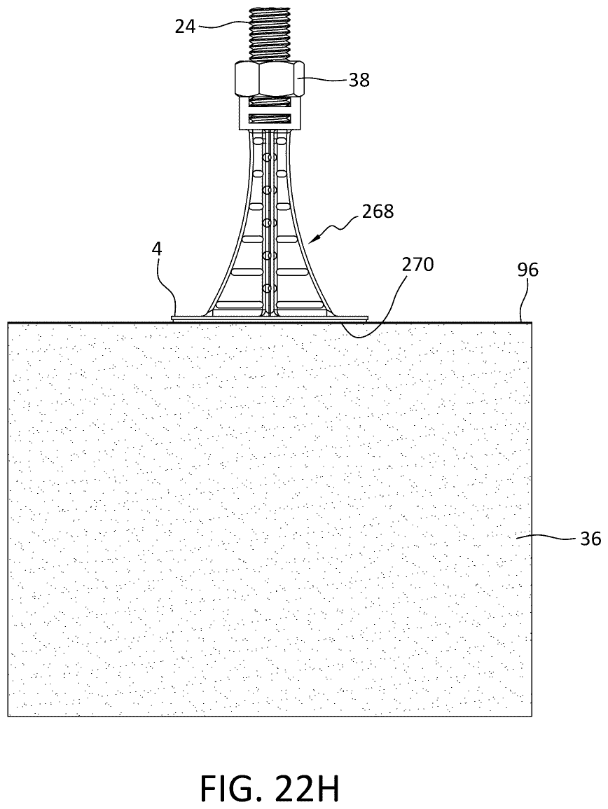

Referring to FIGS. 21A-22B, the rod holder 2 is shown installed over the moisture barrier 96. The tube portion 10 penetrates the moisture barrier 96. The tube portion has an internal thread 260 for threading with the stake rod 34. The base portion 4 is devoid of openings, including the portion 30, into which moisture from the ground 36 might seep into the concrete to advantageously protect the anchor rod 24 and the hex nut from corrosion.

Referring to FIG. 21C, an adhesive tape 122 may be used to attach the base portion 4 to the moisture barrier 96 and to seal penetration of the tube portion 10 through the moisture barrier. Sealing the penetration opening ensures that moisture from the ground cannot migrate to the concrete through the penetration, thus protecting the anchor rod 24 and the hex nut 38 in the concrete from corrosion.

Referring to FIG. 21D, the rod holder 2 advantageously provides the required separation distance 262, generally 3 inches, between the soil 36 and the bottom of the anchor rod 24 to advantageously isolate the anchor rod from the ground moisture.

Referring to FIG. 22A, another embodiment of a rod holder 264 is disclosed. The rod holder 264 is similar to the rod holder 40, except that the spike portion 46 is replaced with a conical slotted tube 268 with internal thread 260. The rod holder 264 is preferably made of plastic or other suitable materials to advantageously isolate the anchor rod 24 from the ground.

Referring to FIG. 22B, another embodiment of a rod holder 268 similar to the rod holder 40 without the spike portion 46 is disclosed. The base portion 4 has an unobstructed flat bottom surface 5.

The holders 264 and 268 are preferably made of plastic or other suitable materials to advantageously isolate the anchor rod 24 from the ground moisture for protection against corrosion.

Referring to FIGS. 22C-22E, the rod holder 264 is shown installed over a vapor barrier 96 with a stake rod 34 threaded to the internal thread inside the conical tube 266. An adhesive tape 122 may be used on top of the base portion 4 to seal the base portion 4 to the vapor barrier 96, thereby to seal the penetration of the moisture barrier 96 by the ground rod 34.

Referring to FIGS. 22F-22G, a double-sided adhesive tape 270 may be attached to the bottom surface 5 of the base portion 4 and the vapor barrier 96.

Referring to FIG. 22H, the rod holder 268 is shown attached to the vapor barrier 96 with a double-sided adhesive tape 270 also attached to the bottom surface 5 of the base portion 4.

The rod holders disclosed herein advantageously provide the required separation distance between the exposed ground surface and the bottom of the anchor rod 24 or bolt.

Referring to FIGS. 23A-23E, a sealing member 272 is disclosed. The sealing member 272 is used to seal the penetration opening 278 of the moisture barrier 96 by the ground rod 34. The sealing member 272 is preferably circular, with a flat bottom 292 and a substantially flat top surface except at the center portion 274, which is thicker than the rest of the member 272. The center portion 274 has a threaded opening 276 for threaded attachment to the ground rod 34.

The sealing member 272 is preferably made of plastic material that is elastic, flexible and/or squeezable, such as TPU or TPE material plastic material available from Americhem, Desmopan by Covestro, Ninjatek (Fenner Precision Polymers) or Sain Smart, so as to make a sealing engagement with the ground rod 34. Other similar materials, such silicone or rubber material, may also be used.

Thermoplastic polyurethane (TPU) is a type of plastic that combines the characteristics of both rubber and plastic, offering properties such as elasticity, transparency, resistance to oil, grease, abrasion, and can be processed through methods like injection molding, extrusion, blow molding.

Thermoplastic elastomers (TPE) are a class of copolymers or a physical mix of polymers that combine the properties of thermoplastics and elastomers. They exhibit both thermoplastic and elastomeric properties, allowing them to be shaped into fabricated articles when heated and to return to their original shape after cooling. TPEs exhibit a wide range of physical properties, such as flexibility and elasticity similar to rubber, and strong tear and abrasion resistance.

Referring to FIG. 23D, the sealing member 272 is shown sealingly threaded to the ground rod 34 to advantageously seal the penetration opening 278 in the moisture barrier 96. Sealing the penetration opening ensures that moisture from the ground cannot migrate to the concrete through the penetration opening, thus protecting the anchor rod 24 from corrosion. The opening portion 284 flexes and squeezes into the thread to provide the seal.

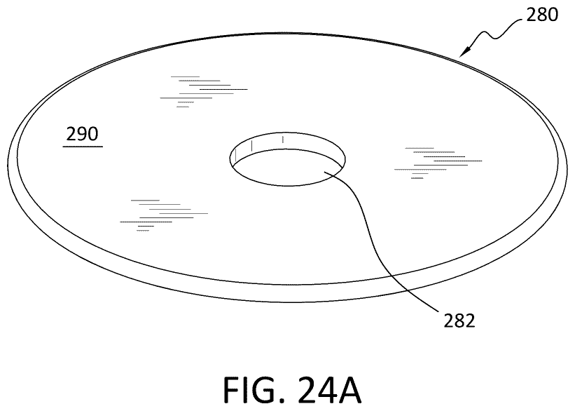

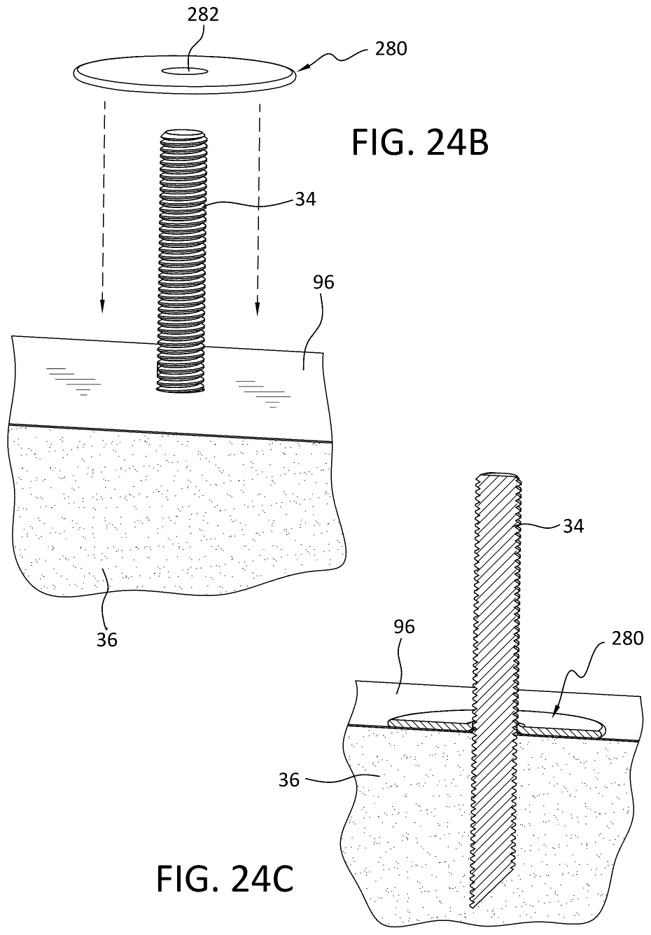

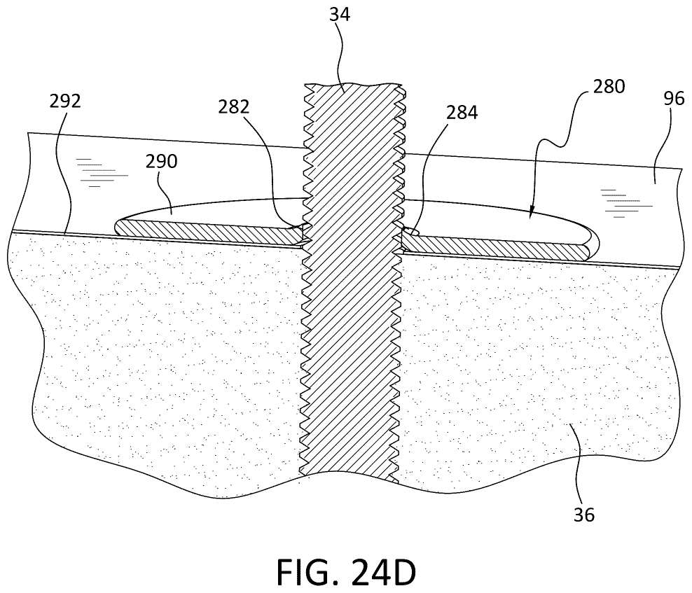

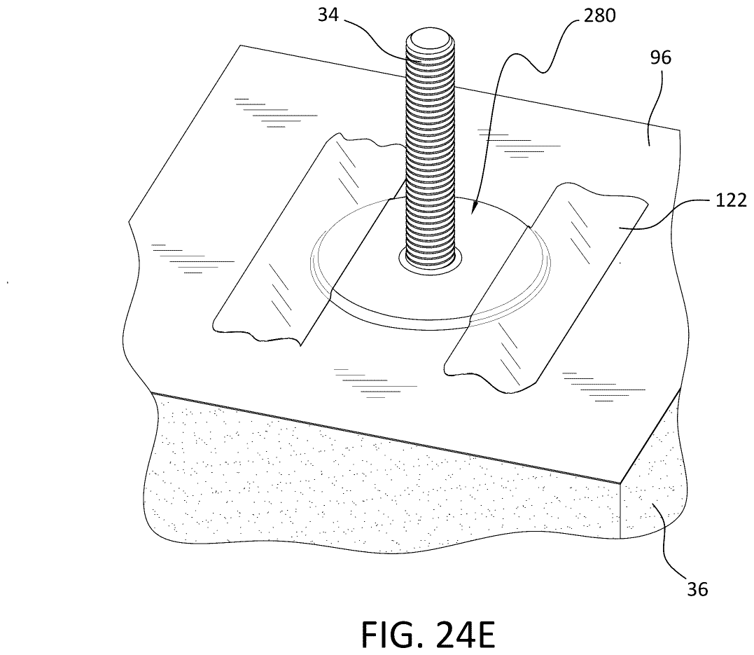

Referring to FIGS. 24A-24F, the sealing member 272 is modified as sealing member 280. The sealing member 280 is the same as the sealing member 272, except that the opening 282 is not threaded and the thicker center portion 274 is not present. The top and bottom surfaces 290 and 292 are preferably flat. The sealing member 280 is preferably disc shaped. The opening 282 is smaller than the diameter of the ground rod 34 so that a portion 284 around the opening 282 flexes and squeezes against the thread of the rod 34 to advantageously form a sealing contact around the ground rod 34. Adhesive tape 122 may be used to press down the sealing member 280 onto the moisture barrier 96 to advantageously provide greater contact surface area between the bottom surface 292 of the sealing member 280 and the top surface of the moisture barrier 96. An adhesive 286 may used to provide greater sealing contact between the bottom surface 292 of the sealing member 280 to the top surface of the moisture barrier 96. The adhesive 286 may be in the form of a two-sided adhesive tape. The adhesive 286 may be used with the sealing members 272, 280 and 288.

Although only shown with the ground rod 34 in FIGS. 23C and 24C, the openings 276 and 282 may also be configured to seal around the thread 150 of the base portion 140 (see FIGS. 8B, 9B, 9C, 9D) when used as shown, for example, in FIGS. 10A, 10B, 11E, 13A, or 13E. The openings 276 and 282 may also be used with an unthreaded rod, with the opening portion 284 squeezing and flexing around the rod to seal the periphery of the openings against the rod.

The sealing members 272 and 280 may be used where the ground rod or the rod holder penetrates the moisture barrier 96, such as shown, for example, in FIGS. 10A, 10B, 11E, 12A, 12B, 13E, 21B, 22D or 22G. The use of the sealing members 272 and 280 also simplifies the method of sealing the penetration opening 278 in the moisture barrier 96, advantageously replacing several components, such as the washers 186 and the plastic nuts 80 shown, for example, in FIGS. 12D, 13B, 13C, or 13D.

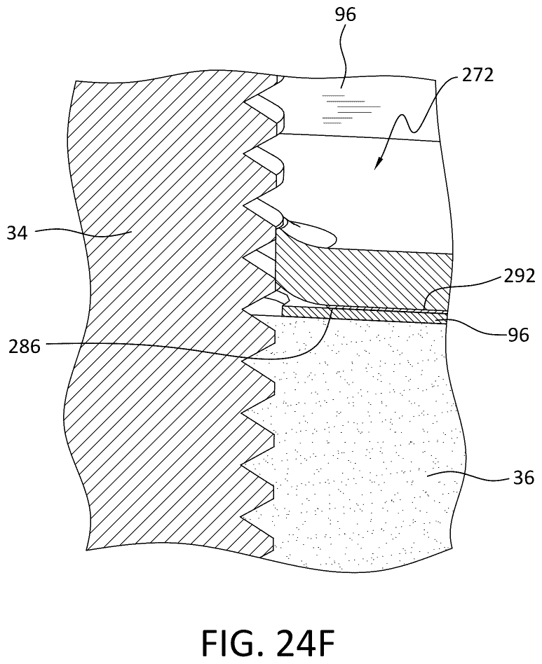

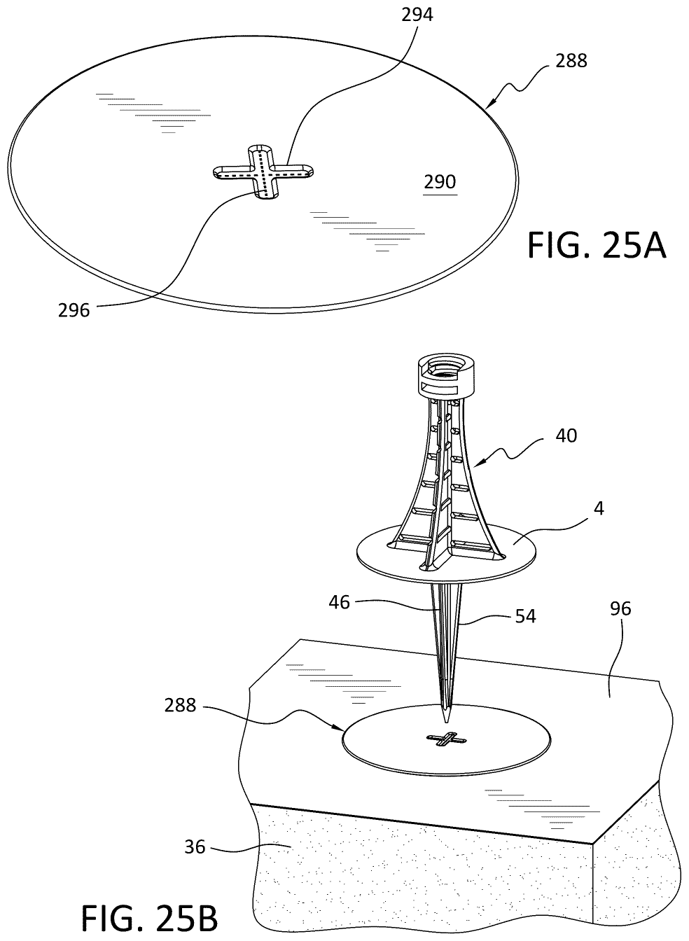

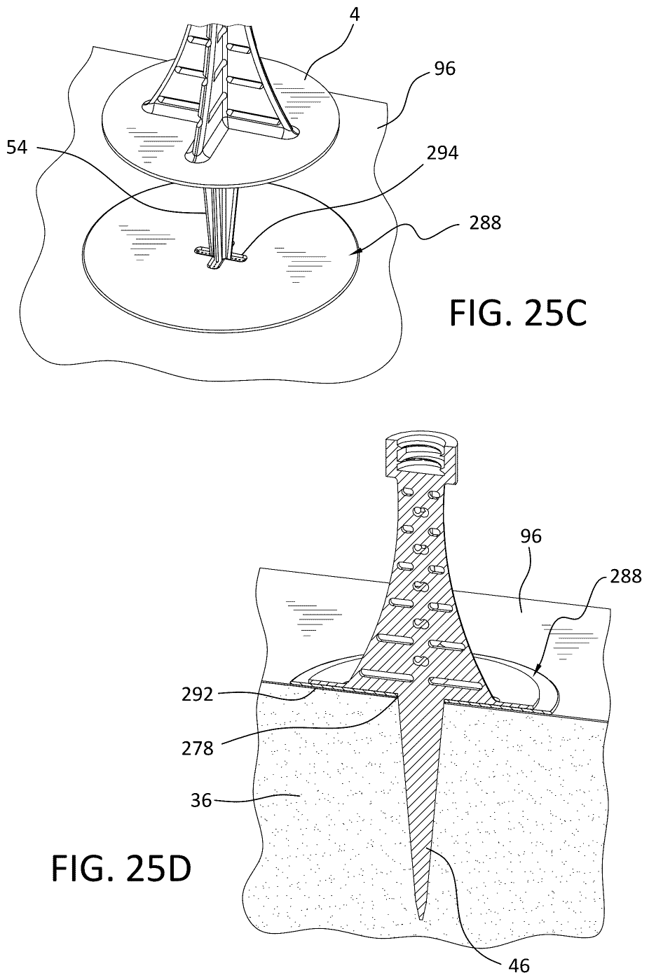

Referring to FIGS. 25A-25C, another embodiment of a sealing member 288 is disclosed. The sealing member 288 is made of the same material as the sealing members 272 and 280. The sealing member 288 has flat top and bottom surfaces 290 and 292 so as to properly support the flat bottom surface 5 of the base portion 4 of the holder 40. A cross-shaped recess 294 with perforations 296 is provided preferably at the center of the sealing member 288. The recess 294 preferably corresponds to the shape and size of the cross-section of the spike portion 46 at the bottom surface 5. The perforations 296 are designed to break when the spike portion 46 is pushed through the recess 294 and the moisture barrier 96. The adhesive 286 may be used between the bottom surface 5 of the base portion 4 and the moisture barrier 96 to provide additional sealing for the penetration opening 278. The recess 294 may also take the form of an opening of the same shape.

The sealing member 280, with its flat top and bottom surfaces 290 and 292, is advantageously used in holders with a flat bottom surface 5, such as holders 2, 40, 264 (FIGS. 21A, 22F, 22A).

It should be understood that the rod 24 shown attached to any of the holders disclosed herein may be terminated with the coupler 56 and embedded in concrete, for example as shown in FIG. 16C. The rod 24 may also terminate above the concrete surface 62 and be attached to a structure above the concrete structure 81. The concrete structure 81 is slab on grade when poured over the surface of the ground 36, with or without the moisture barrier 96. Thus, the assemblies shown, for example, in FIGS. 2B, 3B, 5A, 6A, 10A, 12C-12D, 13A-13C, 13E, 15A, 15C, 15E, 15H, 21A, 21C, 22C and 22G are understood to be embedded in the concrete structure, such as shown in FIG. 16C.

It should be understood that the holders 2, 40, 154, 160, 162, 164 and 264 disclosed herein are not limited to holding an anchor rod. For example, the assemblies shown in FIGS. 2A, 3B, 10A and 11B without the rod 24 and hex nut 38, such as that shown in FIG. 13D, may also be used to support and position items such as electrical conduits, plumbing pipes, electrical junction boxes and/or other structures above the moisture barrier 96 and inside the concrete slab prior to concrete pouring. The holders advantageously provide the required distance above the moisture barrier 96 for corrosion protection. The ground rod 34 advantageously maintains the location of the holders prior to and during concrete pouring.

It should be understood that the various features shown in a particular combination in an embodiment of the anchor rod holder assembly are equally applicable and may be interchanged with the other features shown in another configuration of the anchor rod holder assembly to arrive at different configurations even though not specifically disclosed in combination with the other embodiments.

While this invention has been described as having preferred design, it is understood that it is capable of further modifications, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

1. A holder for a rod to be embedded in concrete, comprising:
a) a head portion elevated from a base portion by a support portion;
b) the head portion including an opening for receiving an end portion of a rod; and
c) the base portion for being attached to a concrete form surface, the holder being made of plastic to protect from corrosion the end portion of the rod.

2. The holder as in claim 1, wherein the opening is threaded.

3. The holder as in claim 1, wherein the head portion has arm portions.

4. The holder as in claim 1, wherein the opening has a stop portion to limit penetration of the end portion of the rod into the opening.

5. The holder as in claim 1, wherein the base portion has a flat bottom surface.

6. The holder as in claim 5, wherein the base portion has a tube portion extending downwardly from the bottom surface.

7. The holder as in claim 6, wherein the tube portion has internal thread.

8. The holder as in claim 5, wherein the tube portion has a conical outside surface.

9. The holder as in claim 1, wherein the base portion comprises a projection with an external thread for attachment to another holder.

10. The holder as in claim 1, wherein the base portion comprises a projection with an opening with an internal thread.

11. The holder as in claim 1, wherein the base portion comprises a spike portion for insertion into the ground.

12. The holder as in claim 1, wherein the support portion comprises a plurality of leg portions.

13. The holder as in claim 3, wherein the support portions comprises adjacent members supporting adjacent arm portions in the head portion.

14. The holder as in claim 1, wherein the support portion comprises a single member.

15. The holder as in claim 1, wherein the support portion is X-shaped in cross-section.

16. The holder as in claim 15, wherein the support portion is tapered being wide at the base portion and narrow at the head portion.

17. The holder as in claim 1, and further comprising a flat flexible sealing member disposed below the base portion.

18. The holder as in claim 17, wherein the sealing member has a central opening.

19. A holder for a rod to be embedded in concrete, comprising:
a) a head portion having alternating first and second U-shaped portions defining a first opening;
b) a first base portion having third and fourth alternating U-shaped portions defining a second opening; and
c) a barrier wall located between the head portion and the first base portion to isolate the first opening from the second opening.

20. The holder as in claim 19, wherein the first opening and the second opening are threaded for attached to a first rod and a second rod, respectively.

21. The holder as in claim 19, wherein the first opening has a larger diameter than the second opening.

22. The holder as in claim 19, wherein the first base portion has an exterior thread.

23. The holder as in claim 19, wherein the first opening is angled relative to the second opening.

24. The holder as in claim 17, wherein the first base portion is attached to a second base.

25. The holder as in claim 17, wherein a first rod is attached to the first base portion, the first rod for being driven into a ground surface.

26. The holder as in claim 25, wherein a moisture barrier is disposed on the ground surface.

27. The holder as in claim 17, wherein:
a) a coupler has a first end and a second end;
b) the first end is attached to the first base portion; and
c) a first rod is attached to the second end.

28. The holder as in claim 27, wherein:
a) a moisture barrier is disposed on the ground surface;
b) the second end is attached to the moisture barrier.

29. An anchor rod assembly to be embedded in concrete, comprising:
a) a moisture barrier for being disposed on a ground surface;
b) a body with a flat bottom surface supported on the moisture barrier;
c) the body has an opening; and
d) a rod is operably attached to the opening.

30. The anchor rod assembly as in claim 29, wherein the opening is threaded.

31. The anchor rod assembly as in claim 29, wherein the opening has a bottom wall to separate the end of the rod from the ground surface.

32. An anchor rod assembly for being disposed on a moisture barrier on a ground surface, comprising:
a) a body for being supported on the moisture barrier;
b) the body has an opening;
c) a rod holder has a first end and a second end;
d) the first end is attached to the opening of the body; e) a rod has an end portion attached to the second end; and
f) the second end has an opening for receiving the end portion of the rod.

33. An anchor rod assembly to be embedded in concrete, comprising:
a) a rod holder for being positioned on a concrete form surface;
b) a rod having a first end portion and a second end portion, the first end portion being operably attached to the rod holder;
c) an anchor body attached to the rod;
d) a coupler having a first end opening and a second end opening, the first end opening being attached to the second end portion of the rod, the second end opening for being attached to a load; and
e) the first end opening having an internal thread with a first portion for minimum thread engagement of the second end portion of the rod, and a second portion for height adjustment of the coupler, the second portion being deeper into the first end opening than the first portion, the coupler being adjustable within the second portion relative to a reference point.

34-45. (canceled)

46. A coupler to be embedded in concrete, comprising:
a) a body having a first end portion and a second end portion;
b) the first end portion including a threaded first opening, the second end portion including a threaded second opening, the first end portion for being accessible for attaching a threaded rod after concrete is poured around the coupler;
c) an internal partition wall is disposed between the threaded first opening and the threaded second opening to seal the threaded first opening from the threaded second opening; and
d) the threaded first opening has a first minimum thread engagement depth.

47-49. (canceled)

50. A coupler to be embedded in concrete, comprising:
a) a body having a first end portion and a second end portion;
b) the first end portion including a threaded first opening, the second end portion including a threaded second opening, the first end portion for being accessible for attaching a first threaded rod after concrete is poured around the coupler; and
c) the body having a threaded first opening with a first portion for minimum thread engagement of a rod and a second portion for height adjustment of the body, the second portion being deeper into the threaded first opening than the first portion, the body being adjustable within the second portion relative to a reference point.

51. A coupler for being embedded in concrete, comprising:
a) a body having a first end portion and a second end portion;
b) the first end portion including a threaded first opening, the second end portion including a threaded second opening, the first end portion for being accessible for attaching a first threaded rod after concrete is poured around the coupler, the threaded second opening for receiving an end portion of a second rod;
c) an interior partition wall disposed between the threaded first opening and the threaded second opening to seal the threaded first opening from the threaded second opening; and
d) the second end portion including a first sight hole located immediately below a bottom surface of the interior partition wall for allowing wet concrete to fill a void between a top of the second rod and the partition wall.

52. A threaded rod for attachment to a coupler embedded in concrete, wherein the threaded rod comprises:
a) a threaded first end for being threaded to a coupler already embedded in concrete;
b) the threaded rod having a first reference point above the threaded first end; and
c) the first reference point being a known distance above a second reference point after the threaded rod is threaded to the coupler, the distance for indicating that the threaded rod has penetrated the coupler with minimum thread engagement.

53-56. (canceled)

57. A holder for positioning an item inside a concrete slab on grade prior to concrete pouring, comprising:
a) a head portion elevated from a base portion by a support portion;
b) the head portion including an opening for attaching to the item; and
c) the base portion for being attached to a concrete form surface, the holder being made of plastic to protect the item from corrosion.
